(19) United States
(12) Patent Application Publication
(10) Pub. No.: US 2012/0053070 A1
(43) Pub. Date: Mar. 1, 2012

(54) Genetic Risk Analysis In Reward Deficiency Syndrome

(76) Inventors: Kenneth Blum, San Diego, CA (US); William B. Downs, Lederach, PA (US); Roger L. Waite, San Diego, CA (US); William J. Heaney, Huntington Beach, CA (US)

(21) Appl. No.: 13/092,894

(22) Filed: Apr. 22, 2011

Related U.S. Application Data
(60) Provisional application No. 61/326,755, filed on Apr. 22, 2010.

(51) Int. Cl. C40B 30/04; C40B 40/06

(52) U.S. Cl. 506/9; 506/16

(57) ABSTRACT

Methods and kits for performing genetic analyses of biological samples to assess predisposition for and/or to stratify risk Reward Deficiency Syndrome (RDS) behavior, including various addictive and/or compulsive behaviors, are described. The methods and kits of the invention use different nucleic acid probes to determine if a human subject's genome contains one or more alleles for one or more genes implicated in RDS.

### RELATED APPLICATION

This application claims the benefit of and priority to U.S. provisional patent application Ser. No. 61/326,755, filed 22 Apr. 2010, the contents of which are hereby incorporated in their entirety for any and all purposes.

### BACKGROUND OF THE INVENTION

1. Field of the Invention

The present invention relates generally to predicting development of and stratifying risk for Reward Deficiency Syndrome (RDS) based on genetic analysis.

2. Overview

The following description includes information that may be useful in understanding the present invention. It is not an admission that any such information is prior art, or relevant, to the presently claimed inventions, or that any publication specifically or implicitly referenced is prior art.

Dopamine is a neurotransmitter in the brain, which controls feelings of wellbeing. This sense of wellbeing results from the interaction of dopamine and neurotransmitters such as serotonin, the opioids, and other brain chemicals. Low serotonin levels are associated with depression. High levels of the opioids (the brain's opium) are also associated with a sense of wellbeing.

Dopamine has been called the “anti-stress” and/or “pleasure” molecule. When released into the synapse, dopamine stimulates a number of receptors (D1-D5), which results in increased feelings of wellbeing and stress reduction. The mesocorticolimbic dopaminergic pathway plays an important role in mediating reinforcement of natural rewards such as food and sex, as well as unnatural rewards such as drugs of abuse. Natural rewards include satisfaction of physiological drives (e.g. hunger and reproduction) and unnatural rewards are learned and involve satisfaction of acquired pleasures such as hedonic sensations derived from alcohol and other drugs, as well as from gambling and other risk-taking behaviors.

The DRD2 gene is responsible for the synthesis of dopamine D2 receptors. And, further depending on the genotype (allelic form A1 versus A2), the DRD2 gene dictates the number of these receptors at post-junctional sites. A low number of D2 receptors leads to hypodopaminergic function. When there is a paucity of dopamine receptors, the person is more prone to seek any substance or behavior that stimulates the dopaminergic system. The D2 receptor has been associated with pleasure, and the DRD2 gene has been referred to as a reward gene. Although the DRD2 gene, and especially the Taq1 A1 allele, has been most associated with neuropsychiatric disorders in general and in alcoholism in particular, it is likely involved in other addictions (e.g., carbohydrate). It may also be involved in co-morbid antisocial personality disorder symptoms, especially in children and adults with attention deficit hyperactivity disorder (ADHD), or Tourette's Syndrome, and high novelty seeking behaviors.

Reward Deficiency Syndrome was first defined in 1996 as a putative predictor of impulsive and addictive behaviors. Herein, “Reward Deficiency Syndrome” or “RDS” refers to a group of related addictive behaviors. Dopamine is a major component in the mechanisms related to RDS and brain function. Specifically, RDS involves dopamine resistance, a form of sensory deprivation of the brain's reward or pleasure mechanisms. The syndrome can be manifested in relatively mild or severe forms that follow as a consequence of an individual's biochemical inability to derive reward from ordinary, everyday activities. The DRD2 A1 genetic variant is also associated with a spectrum of impulsive, compulsive, and addictive behaviors. RDS unites these disorders and explains how certain genetic anomalies give rise to complex aberrant behavior.

In discussing RDS, specific reference is made to an insensitivity and inefficiency in the brain's reward system. There may be a common neurocircuitry, neuroanatomy, and neurobiology for multiple addictions and for a number of psychiatric disorders. Due to specific genetic antecedents and environmental influences, a deficiency of the D2 receptors may predispose individuals to a high risk for multiple addictive, impulsive, and compulsive behaviors. It is well known that alcohol and other drugs of abuse, as well as most positive reinforcements (e.g., sex, food, gambling, aggressive thrills, etc.), cause activation and neuronal release of brain dopamine, which can decrease negative feelings and satisfy abnormal cravings for substances such as alcohol, cocaine, heroin, and nicotine, which, among others, are linked to low dopamine function.

In individuals possessing an abnormality in the DRD2 gene, the brain lacks enough dopamine receptor sites to achieve adequate dopamine sensitivity and function from the “normal” dopamine produced in the Reward Center of the brain. Carriers of the A1 DRD2 gene variant may have unhealthy appetites, abuse cocaine, indulge in overeating (which can lead to obesity) or, on the other extreme, be anorexic and/or suffer greater consequences of chronic stress. In these individuals, their addictive brains lead to generalized craving behavior. In essence, they seek substances including alcohol, opiates, cocaine, nicotine, and/or glucose (all substances known to cause preferential release of dopamine at the Nucleus accumbens) to activate dopaminergic pathways in order to offset their low D2 receptors, which are caused by the dopamine D2 receptor gene Taq1 A1 allele antecedents. The DRD2 A1 polymorphism is also associated with abnormally aggressive behavior, which also stimulates the brain's use of dopamine.

The inventors believe RDS is linked to flawed dopamine metabolism, and especially to low D2 receptor density. Moreover, RDS results from a dysfunction in the mesolimbic system of the brain, which directly links abnormal craving behavior with a defect in the Dopamine D2 Receptor Gene (DRD2) as well as other dopaminergic genes (D1, D3, D4, and D5, DATA1, MAO, COMT), including many genes associated with the brain reward function, as listed in Table 1, below, and as illustrated in FIG. 1.

TABLE 1
Genes involved in various Reward
Dependence Pathways (see FIG. 1)

| Reward Dependence Pathway | Genes |
|---|---|
| Signal Transduction | ADCY7 |
| Signal Transduction | AVPR1A |
| Signal Transduction | AVPR1B |
| Signal Transduction | CDK5R1 |
| Signal Transduction | CREB1 |
| Signal Transduction | CSNKLE |
| Signal Transduction | FEV |
| Signal Transduction | FDS |
| Signal Transduction | FOSL1 |
| Signal Transduction | FOSL2 |
| Signal Transduction | GSK3B |
| Signal Transduction | JUN |
| Signal Transduction | MAPK1 |
| Signal Transduction | MAPK3 |
| Signal Transduction | MAPK14 |
| Signal Transduction | MPD2 |
| Signal Transduction | MGFB |
| Signal Transduction | NTRK2 |
| Signal Transduction | NTSR1 |
| Signal Transduction | NTSR2 |
| Signal Transduction | PPP1R1B |
| Signal Transduction | PRKCE |
| Serotonin | HTRIA |
| Serotonin | HTRIB |
| Serotonin | HTR2A |
| Serotonin | HTR2C |
| Serotonin | HTR3A |
| Serotonin | HTR3B |
| Serotonin | MAOA |
| Serotonin | MAOB |
| Serotonin | SLC64A |
| Serotonin | TPH1 |
| Serotonin | TPH2 |
| Opioid | OPRMI |
| Opioid | OPRKI |
| Opioid | PDYN |
| Opioid | PMOC |
| Opioid | PRD1 |
| Opioid | OPRL1 |
| Opioid | PENK |
| Opioid | PNOC |
| GABA | GABRA2 |
| GABA | GABRA3 |
| GABA | GABRA4 |
| GABA | GABRA6 |
| GABA | GABRB1 |
| GABA | GABRB2 |
| GABA | GABRB3 |
| GABA | GABRD |
| GABA | GABRE |
| GABA | GABRG2 |
| GABA | GABRG3 |
| GABA | GABRQ |
| GABA | SLC6A7 |
| GABA | SL6A11 |
| GABA | SLC32A1 |
| GABA | GAD1 |
| GABA | GAD2 |
| GABA | DB1 |
| Dopamine | COMT |
| Dopamine | DDC |
| Dopamine | DRD1 |
| Dopamine | DRD2 |
| Dopamine | DRD3 |
| Dopamine | DRD4 |
| Dopamine | DRD5 |
| Dopamine | SLC18A2 |
| Dopamine | SLC6A3 |
| Dopamine | TH |
| Cannabinoid | CNR1 |
| Cannabinoid | FAAH |
| Cholinergic | CHRMI |
| Cholinergic | CHRM2 |
| Cholinergic | CHRM3 |
| Cholinergic | CHRM5 |
| Cholinergic | CHRNA4 |
| Cholinergic | CHRNB2 |
| Adrenergic | ADRA1A |
| Adrenergic | ADRA2B |
| Adrenergic | ADRB2 |
| Adrenergic | SLC6A2 |
| Adrenergic | DRA2A |
| Adrenergic | DRA2C |
| Adrenergic | ARRB2 |
| Adrenergic | DBH |
| Glycine | GLRA1 |
| Glycine | GLRA2 |
| Glycine | GLRB |
| Glycine | GPHN |
| NDMA | GR1K1 |
| NDMA | GRINI |
| NDMA | GRIN2A |
| NDMA | GRIN2B |
| NDMA | GRIN2C |
| NDMA | GRM1 |
| Stress | CRH |
| Stress | CRHEP |
| Stress | CRHR1 |
| Stress | CRHR2 |
| Stress | GAL |
| Stress | NPY |
| Stress | NPY1R |
| Stress | NPY2R |
| Stress | NPY5R |
| Drug Metabolizing | ALDH1 |
| Drug Metabolizing | ALDH2 |
| Drug Metabolizing | CAT |
| Drug Metabolizing | CYPZE1 |
| Drug Metabolizing | ADH1A |
| Drug Metabolizing | ADH1B |
| Drug Metabolizing | ADH1C |
| Drug Metabolizing | ADH4 |
| Drug Metabolizing | ADH5 |
| Drug Metabolizing | ADH6 |
| Drug Metabolizing | ADH6 |
| Drug Metabolizing | ADH7 |
| Others | BDNF |
| Others | CART |
| Others | CCK |
| Others | CCKAR |
| Others | CLOCK |
| Others | HCRT |
| Others | LEP |
| Others | NR3C1 |
| Others | SLC29A1 |
| Others | TAC |

3. Definitions

When used in this specification, the following terms will be defined as provided below unless otherwise stated. All other terminology used herein will be defined with respect to its usage in the particular art to which it pertains unless otherwise noted.

By “multiplex” is meant more than one. “Multiplex genetic testing” refers to testing for two or more (e.g., 2-10, 2-100, 2-150, 2-250, 2-500, 2-1,000 or more) mutations or other disease- or disorder-associated genetic differences in a single assay. Genome-wide SNP screening requires simultaneous analysis of multiple loci with high accuracy and sensitivity.

A “patentable” composition, process, machine, or article of manufacture according to the invention means that the subject matter satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically exclude the unpatentable embodiment(s). Also, the claims appended hereto are to be interpreted both to provide the broadest reasonable scope, as well as to preserve their validity. Furthermore, if one or more of the statutory requirements for patentability are amended or if the standards change for assessing whether a particular statutory requirement for patentability is satisfied from the time this application is filed or issues as a patent to a time the validity of one or more of the appended claims is questioned, the claims are to be interpreted in a way that (1) preserves their validity and (2) provides the broadest reasonable interpretation under the circumstances.

A “plurality” means more than one.

The term “polymorphism” refers to the presence of two or more alternative genomic sequences or alleles for a given genetic locus, be it protein-coding region, a regulatory region, or locus having another function. A polymorphism may be between or among different genomes or individuals, or between different copies of the same locus within the same genome. “Polymorphic” refers to a situation in which two or more variants of a specific genomic sequence can be found in a population. A “polymorphic site” is the locus at which the variation occurs. A “single nucleotide polymorphism”, or “SNP’, is a single base-pair variant, typically the substitution of one nucleotide by another nucleotide at the polymorphic site. Deletion or insertion of a single nucleotide also gives rise to SNPs. While the terms “SNP” and “SNP detection” are used throughout the specification, herein the term is also understood to encompass double and multiple nucleotide polymorphisms.

By “positive predictive value” is meant the probability that a subject having a true-positive result for the marker(s) or target analyte(s) being assayed has or will develop a disease or order associated or correlated with the true-positive result(s).

By “sensitivity” is meant a true-positive result.

By “specificity” is meant a true-negative result.

### SUMMARY OF THE INVENTION

The object of the invention is to provide new, patentable articles and methods for detecting genetic polymorphisms, particularly single nucleotide polymorphisms (SNPs), in a biological sample obtained from a subject in order to determine if the subject has a predisposition or susceptibility to Reward Deficiency Syndrome (RDS), as well as to provide an RDS diagnosis, to confirm an RDS diagnosis derived by other means (e.g., clinical evaluation), and/or to stratify RDS risk, by providing a “genetic addiction risk score” (GARS). Thus, one aspect of the invention concerns methods for high-throughput or multiplex genetic screening or testing to determine whether nucleic acids in a nucleic acid-containing biological sample obtained from a subject contain two or more genetic polymorphisms associated or correlated with RDS. Such methods can be qualitative or quantitative.

In general, the methods of the invention concern the efficient, sensitive, multiplex analysis of nucleic acids from biological samples obtained from subjects suspected or known to have or be at risk for developing RDS or an RDS-associated behavior. Such methods typically employ polymorphism-(e.g., SNP-) specific probes (preferably oligonucleotides) for RDS-associated alleles. In such methods, SNP-specific probes are hybridized to nucleic acids derived from a biological sample (e.g., whole blood, plasma, serum, skin, saliva, mucous, urine, lymph fluid, a tissue biopsy, a buccal swab, etc.) obtained from a human subject. Depending on the assay format employed, the hybridization may result in probe:target hybrids that does not have any mismatched nucleotide base pairs in the intended area of probe-target hybridization, whereas in other formats, the one or mismatches in the intended area of probe-target hybridization may be present. Probe:target hydrids, if any, are then detected. In formats where no mismatches are present in probe-target hybrids, detection may occur directly by detecting label molecules bound to either the probe or SNP target species. In formats where mismatches are present in probe-target hybrids, further processing, for example, by enzymes that recognize and cleave captured probe-target hybrid molecules at mismatched base pairs, may be required before the detection of labeled molecules occurs on the cleaved hybrid molecules.

A related aspect of the invention concerns kits for performing the various methods of the invention.

Another aspect of this invention involves the development of mathematical predictive values of based on RDS-associated alleles necessary for determining and/or stratifying genetic RDS risk.

These and other aspects and embodiments of the invention are discussed in greater detail in the sections that follow. The foregoing and other aspects of the invention will become more apparent from the following detailed description, accompanying figures, and the appended claims. The descriptions and figures that follow are illustrative only and not intended to be limiting.

### BRIEF DESCRIPTION OF THE FIGURES

A brief summary of each of the figures is provided below.

FIG. 1 illustrates 130 RDS-associated genes in several different metabolic pathways.

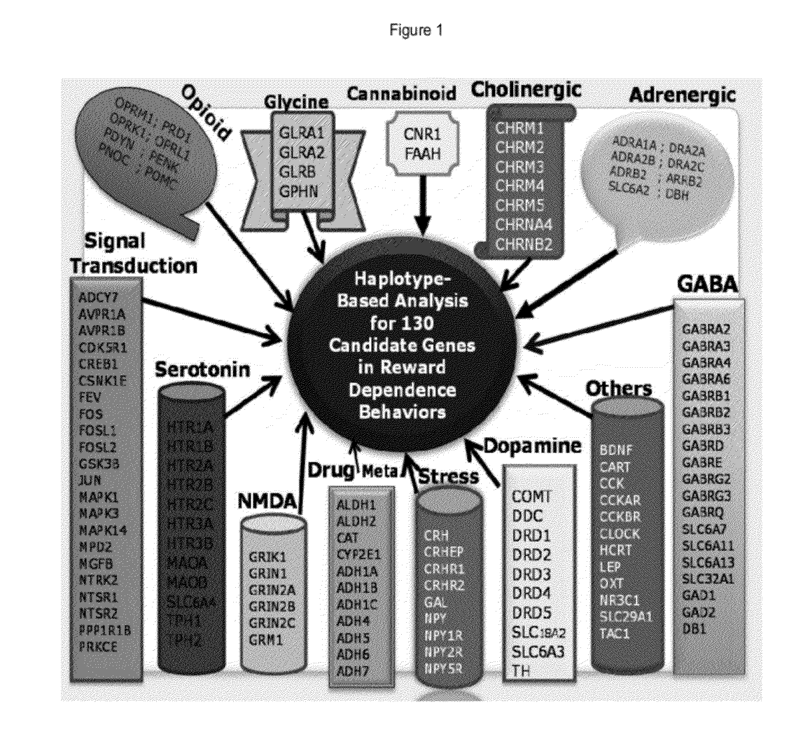

FIG. 2 shows two schematic representations of the brain reward cascade.

### DETAILED DESCRIPTION

1. Introduction.

The genesis of all behaviors, be it “normal” (socially acceptable) or “abnormal” (socially unacceptable), derives from an individual's genetic makeup at birth. This genetic predisposition, due to multiple gene combinations and polymorphisms, is expressed differently based on numerous environmental factors including family, friends, educational and socioeconomic status, environmental contaminant exposure, and the availability of psychoactive drugs, including food. The core of predisposition to these behaviors is a set of genes, which promote a feeling of wellbeing via neurotransmitter interaction at the “reward center” of the brain (located in the meso-limbic system), leading to normal dopamine release.

Subjects afflicted with RDS carry polymorphic genes in dopaminergic pathways that result in hypo-dopominergic function caused by a reduced number of dopamine D2 receptors, reduced synthesis of dopamine (by dopamine beta-hydroxylase), reduced net release of pre-synaptic dopamine (from, e.g., the dopamine D1 receptor), increased synaptic clearance due to a high number of dopamine transporter sites (dopamine transporter), and low D2 receptor densities (dopamine D2 receptor), making such people more vulnerable to addictive behaviors. The RDS concept involves shared genes and behavioral tendencies, including dependence on alcohol, psycho-stimulants, marijuana, nicotine (smoking), and opiates, altered opiate receptor function, carbohydrate issues (e.g., sugar-binging), obesity, pathological gambling, sex addiction, premeditated aggression, stress, pathological aggression, and certain personality disorders, including novelty-seeking and sex addiction. The common theme across all of these substances and behaviors is that they induce pre-synaptic dopamine release. Spectrum disorders such as ADHD, Tourette's Syndrome, and Autism are also included due to dopamine dysregulation.

Very few behaviors depend upon a single gene. Complexes of genes (polygenic) drive most of heredity-based human actions, and RDS is no exception. For example, DRD2 and DAT1 gene polymorphisms are significantly associated with reward-dependent traits such as cocaine dependence. As a polygenic disorder involving multiple genes and many polymorphisms, RDS likely requires a threshold number of RDS-associated polymorphisms in order to manifest in a particular subject. Unaffected individuals in the population carry some of these alleles. For example, the dopamine D2 receptor gene A1 allele is present in about one-third of unscreened Americans.

This invention has direct implications for both the diagnosis and targeted treatment of RDS behaviors by analyzing the association of dopaminergic genetic polymorphisms. Without being bound to a particular theory, in keeping with the concept of common neurogenetic mechanisms the inventors believe that RDS is a basic phenotype covering many reward behaviors and psychiatric disorders, including spectrum disorders. The invention provides for the first time a polygenic GARS test. Such tests can be used, for example, to determine stratified genetic risk of patients with addictive behaviors upon their entry into a treatment facility, as information about an individual's genetic predisposition to RDS based on the analysis of a number of RDS-associated alleles will be very useful.

2. Multiplex SNP Analysis.

Approximately 0.1% (1 in 1,000) nucleotides differ between any two copies of the human genome. Some of these genetic variations, referred to as “single nucleotide polymorphisms” or “SNPs”, lead to differences in the proteins encoded by genes. Others are “silent”, residing in non-protein coding regions of the genome. SNPs are now being used, for example, to diagnose genetic disorders (e.g., Huntington's disease, Alzheimer's disease, etc.), determine a predisposition to disease (e.g., various forms of cancer), identify or determine the ancestry of a genetic sample, or correlate genetic sequences with phenotypic conditions such as drug response and toxicity.

Single nucleotide polymorphisms can be identified in nucleic acid samples, by any suitable method, including DNA sequencing, restriction enzyme analysis, or site-specific hybridization. High-throughput genome-wide screening for SNPs requires the ability to simultaneously analyze multiple loci with high accuracy and sensitivity.

The present invention utilizes multiplex assays to detect one, several, or many RDS-associated SNPs. RDS-associated SNPs can be identified by any suitable method, including DNA sequencing of patients diagnosed with one or more RDS behaviors. After validation, newly identified RDS-associated SNPs can be used in the practice of the invention. As will be appreciated, once identified and validated, the presence, if any, of one or more RDS-associated SNPs in the nucleic acids derived from a biological sample taken from a patient can be determined using any suitable now known or later-developed assay, including those that rely on site-specific hybridization, restriction enzyme analysis, or DNA sequencing. Table 2, below, lists a number of particularly preferred RDS-associated SNPs the detection of which can be used in the context of the invention.

TABLE 2
RDS-associated SNPs

| | SEQ | | | | SEQ | | |
|---|---|---|---|---|---|---|---|
| | ID | | | | ID | | |
| GENE | NO: | RS # | SNP nucleotide sequence | GENE | NO: | RS# | SNP |
| DRD2 | 1 | RS1800497 | CTGGACGTCCAGCTGGGCGCCT | FTO | 111 | RS1421084 | GCTGTCAGCACCTGGTACAA |
| | | | GCCT[C/T]GACCAGCACTTTGAG | | | | ATACCA[A/G]GATAGGGTTT |
| | | | GATGGCTGTG | | | | TTGGGGCCACATTTT |
| | 2 | RS6278 | AGGAACTCCTTGGCCTAGCCCA | | 112 | RS8050136 | GCATGCCAGTTGCCCACTGT |
| | | | CCCT[G/T]CTGCCTTCTGACGGC | | | | GGCAAT[A/C]AATATCTGAG |
| | | | CCTGCAATGT | | | | CCTGTGGTTTTTGCC |
| | 3 | RS6276 | CTGCTTCCCACCTCCCTGCCCAG | | 113 | RS9939609 | AGGTTCCTTGCGACTGCTGT |
| | | | GCC[A/G]GCCAGCCTCACCCTTG | | | | GAATTT[A/T]GTGATGCACT |
| | | | CGAACCGTG | | | | TGGATAGTCTCTGTT |
| | 4 | RS1079594 | GTCACTATTATGGTTTTTATTAC | | 114 | RS1861868 | GATGACAACATGCAAACTTT |
| | | | TAT[G/T]GCTCTTTTTGAGGA | | | | ATGGCC[A/G]GAAACCAAA |
| | | | ATTGGGAAATT | | | | GAGTCAGGCAAAATAT |
| | 5 | RS6275 | CTGACTCTCCCCGACCCGTCCCA | | 115 | RS9937053 | aaaagaaaGTAAACATATTTA |
| | | | CCA[C/T]GGTCTCCACAGCACTC | | | | AGGTC[A/G]TAAATAAGGC |
| | | | CCGACAGCC | | | | CATGTCTAATAGTGA |
| | 6 | RS1801028 | CCACCAGCTGACTCTCCCCGACC | | 116 | RS9930333 | aggaatgttctgatggcttgg |
| | | | CGT[C/G]CCACCACGGTCTCCAC | | | | cccag[G/T]tggtgactgtg |
| | | | AGCACTCCC | | | | cagatagactgaag |
| | 7 | RS1076560 | ACCCATCTCACTGGCCCCTCCCT | | 117 | RS9939973 | tcagcacccaagggaccatca |
| | | | TTC[A/C]CCCTCTGAAGACTCC | | | | aagag[A/G]ctgttgtggag |
| | | | TGCAAACACC | | | | agggaatccgaagg |
| | 8 | RS2283265 | TTTTGCTGAGTGACCTTAGGCAA | | 118 | RS9940128 | TGGAGTGTTTTTCCTTCACCT |
| | | | GTT[G/T]CTTACCTTCTATGAGC | | | | TTTCC[A/G]GTCTCTGGGTT |
| | | | CTGTTTCCT | | | | GCATCGCCAGACTG |
| | 9 | RS1079727 | TGTGATGAATGGGTGCCAAATA | | 119 | RS1558902 | TGTCTAGCCCTGTGGGTTTA |
| | | | CACA[A/G]ATACAGAATCTAAG | | | | CATTAG[A/T]TAGGGTAGGT |
| | | | AAAACACATGG | | | | TATTGCTGCAACGTA |
| | 10 | RS1076562 | ctagaggaagtgatgttcaacaga | | 120 | RS10852521 | CTATCCAGGATGGCTCTAAA |
| | | | ca[A/G]acaactgaaggatgtgt | | | | GGGACT[C/T]CGCTATAGGT |
| | | | aggaatta | | | | TGGGGCTATGATAGA |
| | 11 | RS1125394 | TGGAAGTCATGTGCTTTGTATG | | 121 | RS1477196 | GCTTATATTCAAAGCTCCAG |
| | | | AAAC[A/G]CCTTGGAATGCTGA | | | | GTAAAT[A/G]TAAGATGTTG |
| | | | TAAGTTTAATT | | | | CTATAATTACCTAAG |
| | 12 | RS4648318 | GTCTAAAGCAAATGGAACCTTT | | 122 | RS1121980 | GGTAGGCAGGTGGATCTGA |
| | | | AGGG[A/G]GAGAGATTTGTGTT | | | | AATCTCA[C/T]ATAGTACCA |
| | | | TGCTGTGTCCC | | | | AGACACGTGACTAGGA |
| | 13 | RS4274224 | GAGGGGACTGGGGTCAGGCCT | | 123 | RS7193144 | ttgattcttatacttttttgtt |
| | | | CATTC[A/G]GGTTCCCTAGAGT | | | | tagt[C/T]gttgaaatatgtt |
| | | | GGAAAGGATTGG | | | | gttttggttgaa |
| | 14 | RS7131056 | GTATcagacagatctaggctcaaata | | 124 | RS16945088 | AATTAGGAAGATTTGAGTA |
| | | | [A/C]cagcttcagttctcaccacct | | | | GCTAAAA[A/G]TTCCAAGAG |
| | | | gtgt | | | | TGGAATAATAGTTTTA |
| | 15 | RS4648317 | CCTGAGTGCACAGGATGCTGGA | | 125 | RS8043757 | TTTGGTGCACTCCCAATTTA |
| | | | GCCT[C/T]CCAGTTTCTCTGGCT | | | | CTCTAA[A/T]CTTCTACGGG |
| | | | TTCATCTCGT | | | | CTTCCTTGGAGAAAC |
| | 16 | RS1799732 | AATCCCCCAACCCCTCCTACCCG | | 126 | RS3751812 | GACCTGAAAATAGGTGAGC |
| | | | TT[-/C]CAGGCCGGGGATC | | | | TGTCAAG[G/T]TGTTGGCAG |
| | | | GCCGAGGAGGTA | | | | GGAGAGGCTCCTCTGG |
| | 17 | RS1799978 | GAGGACCCAGCCTGCAATCACA | | 127 | RS9923233 | tggttcactgcatattcccagt |
| | | | GCTT[A/G]TTACTCTGGGTGTGG | | | | aatt[C/G]gaacaatgcctga |
| | | | GTGGGAGCGC | | | | catgaagtagac |
| 5HT2A | 18 | RS6314 | GCTCAATGGTTGCTCTAGGAAA | | 128 | RS9926289 | TTAGAATGTCTGAATTATTA |
| | | | GCAG[C/T]ATTCTGAAGAGGCT | | | | TTCTAG[A/G]TTCCTTGCGA |
| | | | TCTAAAGACAA | | | | CTGCTGTGAATTTTG |
| | 19 | RS3742278 | CTGTGAACTCAGGAGCAAGTGC | | 129 | RS12597786 | TTGATTTCGGTAGTCATAAC |
| | | | ACAC[A/G]TTGCTTATCACTTAC | | | | ACCACC[C/T]TGGAAGGCAC |
| | | | CAGAAGCATT | | | | CCTAGATAGAGGTCA |
| | 20 | RS6561333 | CTCTGGTTTTAAGCAAGTCATTT | | 130 | RS7185735 | TTCATTCTACCTGTCTTTAGT |
| | | | AAT[—/C/T]GGAGTTTTTTTTCTC | | | | ATCAT[A/G]GGGGTAGTTAC |
| | | | CCATAAAATG | | | | CTCAGCGGGGGTAG |
| | 21 | RS1923886 | aaatggtcctaccatctatccagata | | 131 | RS9931164 | ttgctcaaggtcacacagtaa |
| | | | [C/T]acagcttaaaaacttaggagt | | | | cctta[A/G]gtaggcaggat |
| | | | ctct | | | | aagctctggttctg |
| | 22 | RS2296972 | TGCTATTTGTAATGCTGCTTATT | | 132 | RS9941349 | TATGATGGTTAGGTTAGGTT |
| | | | AGA[G/T]ACATCGCTGATCCTCC | | | | GCAAGT[C/T]TTGGAATATA |
| | | | TGTCAACTC | | | | TGCAGAGGAATAACT |
| | 23 | RS643627 | ATGAACCAAATTGCATGAGCTC | | 133 | RS7199182 | TTATAAACCTCTAAAATAGT |
| | | | TATT[A/G]TGTGCCCCTCTTGTA | | | | TACTAA[A/G]TAAGTTATTC |
| | | | ATATAAAAAT | | | | TTTTAGGTATTTTTC |
| | 24 | RS2770292 | CAGGCAGAATTTCCACAAATGA | | 134 | RS9931494 | TTTTATTTCCGCAATCACTCC |
| | | | AATG[C/G]AAATTCAGATATATA | | | | CTAAT[C/G]TTTATTTCTTTT |
| | | | TCTCTTAATC | | | | TTGCTTCGCATCA |
| | 25 | RS1928040 | TCACTCATAACTGAAGATCATTT | | 135 | RS17817964 | TAGCATTTTTCTGGAGCGTA |
| | | | CAC[C/T]TTTGAATGAGAATTTG | | | | ATTTCA[C/T]AATGTGAATC |
| | | | TCTCTGAAG | | | | AGAAGTCTTAATAGT |
| | 26 | RS2770304 | TGGGCAGAGGAGGGGAAGGGT | | 136 | RS7190492 | GAGCACAGGTGGAGAGAAA |
| | | | CACTG[C/T]ACTCAGGGACAAG | | | | GGGGAGT[A/G]AGAGAAGC |
| | | | AGAAGGGGTGGG | | | | AAAGAAGAAAAGCCTTT |
| | 27 | RS594242 | ATCAGTGTGGTCACTTCACTGCT | | 137 | RS9930506 | TAGGGACACAAAAAGGGAC |
| | | | TGC[C/G]AAGGATTCCATCTAAT | | | | ATACTAC[A/G]TGAATTACT |
| | | | TCTGAGGAA | | | | aatatctaagaaaata |
| | 28 | RS6311 | TATGTCCTCGGAGTGCTGTGAG | | 138 | RS9932754 | ATGAATTACTAATATCTAAG |
| | | | TGTC[C/T]GGCACTTCCATCCAA | | | | AAAATA[C/T]GATACatttgag |
| | | | AGCCAACAGT | | | | aacttagatgaag |
| ANKK1 | 29 | RS2734849 | GGAGGGGGGTCTTGCCCTCAGC | | 139 | RS9922609 | GAAATGTGGTGTAGACGTG |
| | | | CTCA[C/T]GCAGGTTGGGGTCA | | | | ACCCAGG[A/G]GGAAATGA |
| | | | GCCTGACGGGA | | | | GTTTTGTTGGACAGATT |
| | 30 | RS11604671 | CCTGCAAGCTGTCGCTGCGCCA | | 140 | RS7204609 | CTACATCTCCTACTTAGCCG |
| | | | GCCC[A/G]GGGAGGTGAGTGT | | | | AGGTCT[C/T]TTCACTCTCTG |
| | | | GTGGGCTGGGCA | | | | GGCAAGTCTCCTCA |
| | 31 | RS4938016 | ACTTTGCAGCCCAGAATGGGGA | | 141 | RS8044769 | ACACGGCTGAAGAGTCAGG |
| | | | TGAC[C/G]GCACTGCGCGCCTG | | | | AGTGGGA[C/T]GAAAAATA |
| | | | CTCCTGGACCA | | | | CACTTCATTTGTAGGTG |
| OPRK1 | 32 | RS35160174 | AATTTCCCAAAAACTACAGTTTT | | 142 | RS12149832 | GCACATTTATGCCTTTTATAT |
| | | | TTT[—/T]TCTTAGCATGCT | | | | GCCAC[A/G]TACACACGAAA |
| | | | ATTCAGGTAAACA | | | | ACTccatatattct |
| | 33 | RS35373196 | TTTGCTAGGTAAGGTTCAGCAC | | 143 | RS6499646 | agagtgaataaaattatttct |
| | | | CCAT[C/T]TGCTGTGGCCTTCCT | | | | aaatt[C/T]atgcttcatac |
| | | | ATGAAACGTA | | | | cgtgtgataatttg |
| | 34 | RS34709943 | ATGACTAGTCGTGGAGATGTCT | | 144 | RS1421090 | tgttgcaacagagatgatggca |
| | | | TCGT[A/C]CAGTTCTTCGGGAAG | | | | gttt[C/T]ggccacggtgtaa |
| | | | AGAGGAGTTC | | | | gaagcagaggtg |
| | 35 | RS6473797 | GAAAACACAAGTGTGATCAAAT | | 145 | RS2302673 | ACATCTGCCTTCCCAGAGAA |
| | | | GCCA[C/T]GGACCCACAGGAAG | | | | AGGAAA[A/G]TCAATGTTTA |
| | | | CTGGTGGCTCT | | | | AAGTCTATTTAAAAA |
| OPRM1 | 36 | RS510769 | TATATGGCATTTCACATTCACAT | TNF Alpha | 146 | RS1799964 | GGGAAGCAAAGGAGAAGCT |
| | | | GTA[A/G]TATTTGAATATACACA | | | | GAGAAGA[C/T]GAAGGAAA |
| | | | TCAACACCA | | | | AGTCAGGGTCTGGAGGG |
| | 37 | RS553202 | CTAATTAGGATATTTTGTGGGTT | | 147 | RS1800629 | GGAGGCAATAGGTTTTGAG |
| | | | TTA[A/G]AAAAGTGAATTTTATT | | | | GGGCATG[A/G]GGACGGGG |
| | | | AATATTTGA | | | | TTCAGCCTCCAGGGTCC |
| | 38 | RS514980 | acaccacacctggcagttcagAGC | | 148 | RS361525 | TGGCCCAGAAGACCCCCCTC |
| | | | AC[A/G]CTCACTCTTTCTCCCTT | | | | GGAATC[A/G]GAGCAGGGA |
| | | | TGACAGAA | | | | GGATGGGGAGTGTGAG |
| | 39 | RS561720 | ATCAGGTTGGCCTAATTTACGTA | | 149 | RS1800610 | TCTTTCTGCATCCCCGTCTTT |
| | | | AAC[A/G]TTAATTTAAATCACAC | | | | CTCCA[C/T]GTTTTTTTCTCT |
| | | | TAATGGTTT | | | | CCATCCCTCCCTA |
| | 40 | RS534673 | | | 150 | RS3093662 | GTTGAATGCCTGGAAGGTG |
| | | | | | | | AATACAC[A/G]GATGAATG |
| | | | | | | | GAGAGAGAAAACCAGAC |
| | 41 | RS524731 | | MANEA | 151 | RS1133503 | CATTTTACAATAGATAAATG |
| | | | | | | | CTTGTG[C/T]TACCTAAAGC |
| | | | | | | | ACTTAGCACACAGTT |
| | 42 | RS3823010 | AAGAAATTGTCTGCATATAAAC | Leptin OB | 152 | RS4728096 | gctctgggaatgtctatcctat |
| | | | AAAT[A/G]CATCACATTTCCACA | | | | gcaa[C/T]ggagataaggac |
| | | | AAAGACTTTG | | | | tgagatacgccct |
| | 43 | RS3778148 | TGAGAGCTAATGTTTCAAAGAA | | 153 | RS12536535 | atgcaatggagataaggactga |
| | | | ACTT[G/T]AAATTCCCAAGATTA | | | | gata[C/T]gccctggtctcct |
| | | | AAATTATTGT | | | | gcagtaccctca |
| | 44 | RS7773995 | CCCAGTAAGTGAATTAAATACTT | | 154 | RS2167270 | GGAGCCCCGTAGGAATCGC |
| | | | TCA[C/T]AGACACTCTCCATCTA | | | | AGCGCCA[A/G]CGGTTGCA |
| | | | GTAGAACAA | | | | AGGTAAGGCCCCGGCGC |
| | 45 | RS495491 | TGATAGGCACTGGTTCTACAGT | | 155 | RS2278815 | AAGTTCCTGACCTCTGAATG |
| | | | GAGA[C/T]ATATCTCTCCTAAGT | | | | AGAGGG[A/G]CTGTGTAAG |
| | | | CTGGTGACAA | | | | GCCAATGCCTGGGAGG |
| | 46 | RS12333298 | acagtggcacgatctcggctcactgc | | 156 | RS10244329 | aataaaaataaaTGTTCTTCCTT |
| | | | [A/C]acctccacctcccgggtttaa | | | | GCA[A/T]TGAAGTTAAATAT |
| | | | gtga | | | | GTAAATTCTCAA |
| | 47 | RS1461773 | ttacctggctaacagttttctatctc | | 157 | RS11763517 | ACTTAGGTATTAGAGGGTG |
| | | | [C/T]cacacgagcctggtgggaggc | | | | GCCATTA[C/T]TTGAGAGTG |
| | | | agtg | | | | ACTATGACCACAGTTA |
| | 48 | RS1381376 | AGCTCTTGTTATCTTACCATTCC | | 158 | RS11760956 | TGGGTGAATGTGTTATGCTC |
| | | | CAC[A/G]TTGATTCTCATTTTTAT | | | | TCTCCC[A/G]CCACCATGTCT |
| | | | CCCTCTCC | | | | TTATACCCCCTGAT |
| | 49 | RS3778151 | TCAAGATAGCTAATTGAGAACA | | 159 | RS10954173 | CTCCCAGTGGGTGGGAGAG |
| | | | AGCA[C/T]GAGACTCCACTCCTG | | | | AAAGGAC[A/G]TAAGGAAG |
| | | | GTCCCCAAGC | | | | CAAGTGGTAAAGGCCCT |
| | 50 | RS506247 | CCATTTTCTTTTCTTCTTTGCTTG | PEMT | 160 | RS4244593 | atcccttcaccAGAGTGATTTCC |
| | | | TC[G/T]Tttttttctgtttgttt | | | | TCG[A/C]GGCAGGTGCCTG |
| | | | ttcttttc | | | | GGGTAGCCACTGG |
| | 51 | RS563649 | AGAAAATAACTTTTGCTAGATTC | | 161 | RS936108 | GGACTGCCTGGTTGTGCTTC |
| | | | ACC[A/G]TTGGTTATAGACCTGC | | | | GGACCC[A/G]GAGGCAGAC |
| | | | ATGATCTAA | | | | AGAGGAGGCCTTTGAA |
| | 52 | RS9479757 | GTGATGTTACCAGCCTGAGGGA | MAO-A | 162 | RS3788862 | CCCACTAGGCAAGCCTCCTA |
| | | | AGGA[A/G]GGTTCACAGCCTGA | | | | AAAGCA[A/G]TATGGTTGTA |
| | | | TATGTTGGTGA | | | | GATCACTGGAAAATA |
| | 53 | RS2075572 | AGTTAGCTCTGGTCAAGGCTAA | | 163 | RS1465108 | GTAAACATGCAAACTGAAA |
| | | | AAAT[C/G]AATGAGCAAAATGG | | | | CATTAGC[A/G]CCCATTTATT |
| | | | CAGTATTAACA | | | | CAGCATCTTAGAAGA |
| | 54 | RS10485057 | AATTTTATTAGATTAAACAATTT | | 164 | RS909525 | GAGTGAAGGCCAGGTACAG |
| | | | TTA[A/G]CAGACCTCATGCTTGT | | | | AGGAAAT[A/G]AAGCATTCC |
| | | | TGGAGATAA | | | | AAATAATGCCAGGTAA |
| | 55 | RS540825 | GGTCCAGGGTACACAACCAAGC | | 165 | RS2283724 | CCAAAGTTAACTTGTGAACC |
| | | | AGCC[A/T]TGCTCTAGAGCCCA | | | | CTTCTA[A/G]TAAACTGCTC |
| | | | GCAAGACAGGG | | | | CAAGATATGACAAAA |
| | 56 | RS562859 | ACTGAAGAATAATCATGCTTAA | | 166 | RS12843268 | GTTTGCCATGGATGAACCAC |
| | | | CTCA[A/G]GAGAAATGCTCCAC | | | | CAGGAT[A/G]GTGGGGGAG |
| | | | CAGACGGGCTG | | | | ACAGAAAAGGTTGATG |
| | 57 | RS548646 | GCACATTTACTGTTTTGTCTAAC | | 167 | RS1800659 | GGAAAATTCCCCTTCCCCTA |
| | | | CTG[C/T]CTAGCCATTTCAGTCA | | | | AGACAT[C/T]CACCCTTCTG |
| | | | AGCTGATTG | | | | GTTTGGGTAATTCCT |
| | 58 | RS648007 | GCAATCAGAAAGAAATTCAGTT | | 168 | RS6323 | GCAGAGAGAAACCAGTTAA |
| | | | ATTA[C/T]AGTATATGCAAGTCA | | | | TTCAGCG[G/T]CTTCCAATG |
| | | | CACTGCAAGC | | | | GGAGCTGTCATTAAGT |
| | 59 | RS9322447 | AATGAAACACAAATCATAATCTC | | 169 | RS1799835 | GTGCATGATGTATTACAAGG |
| | | | TGA[A/G]GCAAATAAGAATGGA | | | | AGGCC[G/T]TCTGGAAGAA |
| | | | AGGACTCCTG | | | | GAAGGGTAGGCTGCT |
| | 60 | RS681243 | tttagggcaagtcagaaagtccaaaa | | 170 | RS3027400 | AGAGAAGGAAGTGGTGTCC |
| | | | [A/G]tgcctcagatattctgtgtga | | | | CCACAAA[G/T]GAATTGCTA |
| | | | gtga | | | | AGGAGTTCCACAGCCT |
| | 61 | RS609148 | AAAAACTGGGCCTGAGCTCAGA | | 171 | RS979606 | AAGAGAAAACAAAGCTGAA |
| | | | TGAA[C/T]TGGAGAACTGAACT | | | | ATGCTGC[A/G]AGTCAATAA |
| | | | TTGGCTTAGAA | | | | TATCGTTGCTTTAACA |
| | 62 | RS3798687 | GAGTCATCAGCTCCCAAGGTTTT | | 172 | RS979605 | TTTGACAACTATTTCTAGAA |
| | | | CTG[C/T]ATGGCTCTGTTTTTAT | | | | TTTGCA[C/T]TGAACTCTGCT |
| | | | GATTTCTGT | | | | TTTCCTTTTAAATT |
| | 63 | RS648893 | gtgtgtactgcagtctggtcccatcg | | 173 | RS1137070 | GGTCTCGGGAAGGTGACCG |
| | | | [C/T]attgccttgtgggatttggga | | | | AGAAAGA[C/T]ATCTGGGTA |
| | | | gtag | | | | CAAGAACCTGAATCAA |
| COMT | 64 | RS737864 | GCTCCTACGGTCCCTCAGGCTTG | CRH | 174 | RS7209436 | CTGTCCCACAACATGGGGTC |
| | | | GAG[A/G]GTCACTTTAAACAAT | | | | TTACAG[C/T]TCTTTGATGTA |
| | | | AAAAAGCAAC | | | | TCCCCCCACAGGGG |
| | 65 | RS933271 | TGTGGTTACTTTCTGGAGAGAG | | 175 | RS4792887 | GCCTCTGGGGTCACCAGGT |
| | | | CATG[C/T]GGCATGCAGGAGCT | | | | ACATCTT[C/T]GATCTTGGCC |
| | | | GGAGGGGGGGT | | | | ACACTGGAGAGTCAA |
| | 66 | RS5993882 | aaaagttacgcttaataatgaatgtt | | 176 | RS110402 | TTTCTAAACACAGAGGACTG |
| | | | [G/T]cagcactttcttctcttcagg | | | | GTGTTG[C/T]GTTATGCAAA |
| | | | tatt | | | | GAAAAATGCTTCTTA |
| | 67 | RS740603 | CTGTGAGGCACTGAGGATGCCC | | 177 | RS242924 | AAGACACTCAGGTGCAGGG |
| | | | TCAC[A/G]CGTGCATCTGCATGT | | | | ACCCTCT[A/C]CATTTTTGCC |
| | | | GGCGTGCATG | | | | CAGCAGCAGCCATGC |
| | 68 | RS4646312 | CTGGTTTGTGTATGTTCTTGGTA | | 178 | RS242941 | AGGGCCAGGAACCATGAAC |
| | | | AAC[C/T]AGCCCTTGGTCTTACA | | | | CAGCGCG[G/T]GTGGGGGC |
| | | | CATCATTTC | | | | AGCCTCTTCAGGCCTGG |
| | 69 | RS165722 | GCTTCCCTGTTCTCTTCTGCTCTG | | 179 | RS242940 | GGCACACCAGTCCTTTTGAG |
| | | | TC[C/T]TCTGGTGCCCTGAGGCT | | | | CCCCAG[C/T]GTCCCCAGGT |
| | | | GGCCTCCA | | | | TAATAACCTAGAATT |
| | 70 | RS6269 | GGCATTTCTGAACCTTGCCCCTC | | 180 | RS242939 | TGAACACGGAGGCCACACA |
| | | | TGC[A/G]AACACAAGGGGGCG | | | | AGAGTGG[A/G]TTCCAAGT |
| | | | ATGGTGGCACT | | | | GAAGGAGTGACCAACTC |
| | 71 | RS17699 | ATAAGTAACTGTCGAGAAGATT | | 181 | RS242938 | TCCTTTCCTGGGATCACAGA |
| | | | CTCA[C/T]AGGAGACCACGTGG | | | | GGGAAG[C/T]GCGGGGGAG |
| | | | GTTGCCTGAAG | | | | CCTAGAGAGCACCACA |
| SLC6A3 | 72 | RS12516948 | AATGTCCTCAGCTGGTTCTTCCC | | 182 | RS173365 | TACAGGTGAAGGAAAGTGA |
| | | | CCA[A/G]TGCCCTGATCCTGGG | | | | TTCTTTC[C/T]CCGTTAACTT |
| | | | CTCACATGTG | | | | TGTTTCACGCCAGAT |
| | 73 | RS1042098 | GAGACGAAGACCCCAGGAAGT | | 183 | RS1876831 | CCCCCAACCAGAGATGATG |
| | | | CATCC[C/T]GCAATGGGAGAGA | | | | ATGGGGG[A/G]CAGGGGA |
| | | | CACGAACAAACC | | | | GGCACCAAACCCTGGGCC |
| | 74 | RS40184 | AAAATCAAGTAATGATTGATTT | | 184 | RS1876828 | AGCAGCATACCCCTAGGGA |
| | | | GTAG[A/G]AGTTTGAGTGAGGC | | | | CCTAGGA[A/G]CAGGGAGG |
| | | | ATCGGATCCCC | | | | GAGAGAGGCAGCCCTGG |
| | 75 | RS11564773 | ACCGTGCCCAGCCCTGTGTGGG | | 185 | RS937 | CAGCTGGCACTGACAGCCT |
| | | | CATC[A/G]GAGGTGGTTCCCTCT | | | | GGGGGGG[C/G]CGCTCTCC |
| | | | GGTCCTGTCG | | | | CCCTGCAGCCGTGCAGG |
| | 76 | RS11133776 | GTCCAGGCCCCAGGAGCTGCCG | | 186 | RS878886 | GAGCACAAGAAGGCCAGCC |
| | | | CAGC[A/G]GGCAGTGGAAGGA | | | | CACTGGG[C/G]CCTGGGGC |
| | | | AGGCACGTTCAG | | | | TGCCCTCGGCAACCGTG |
| | 77 | RS6876225 | CAGCTTCCCCTCCCAACACAGAG | | 187 | RS242948 | CTGCTTCCCACCAATCAGCA |
| | | | GCG[A/C]GGCCCAAGTGCAGGA | | | | CAGCTC[A/C]TGCCTGGGGC |
| | | | CTCACAACGG | | | | TGGGACACACTCCCG |
| | 78 | RS3776512 | AAGACACAGTGACGGTATACTC | ADIPOQ | 188 | RS17300539 | ATCAGAATGTGTGGCTTGCA |
| | | | ATGA[C/T]GGAATATGATTCGG | | | | AGAACC[A/G]GCTCAGATCC |
| | | | CCTTAAAACAA | | | | TGCCCTTCAAAAACA |
| | 79 | RS2270912 | AAGGCGAAGCCGGCGATGGTA | | 189 | RS2241766 | GTTCTACTGCTATTAGCTCT |
| | | | CGTAC[A/G]TTGGTGACGCAGA | | | | GCCCGG[G/T]CATGACCAG |
| | | | ACAGGGACAGGA | | | | GAAACCACGACTCAAG |
| | 80 | RS6347 | GCCATCGCCACGCTCCCTCTGTC | STS | 190 | RS12861247 | GATGACAAGCCAGGCAGGG |
| | | | CTC[A/G]GCCTGGGCCGTGGTC | | | | AGGAATG[A/G]ACCTGGAT |
| | | | TTCTTCATCA | | | | TCCTGGTGAAGGACGTG |
| | 81 | RS27048 | TGCTTCCTGCTACCAGCAGGCA | VDR | 191 | RS17467825 | GTCAGCGATTCTTAATATAA |
| | | | GACT[C/T]GGATGGAGGTGGAG | | | | GAAAAA[A/G]TGGTGAAAT |
| | | | GGGACGAGAGT | | | | GTGTTTAGAGTGTGCT |
| | 82 | RS37022 | CACGGTAAAAATACAAGGACAG | | 192 | RS731236 | CCTGGGGTGCAGGACGCCG |
| | | | TGTG[A/T]GCAGCAGAATGGCC | | | | CGCTGAT[C/T]GAGGCCATC |
| | | | AGGCAGACCAC | | | | CAGGACCGCCTGTCCA |
| | 82 | RS2042449 | AGGGTTATTAGGATGCTGTGGT | | 193 | RS1544410 | GTTCCTGGGGCCACAGACA |
| | | | CATG[C/T]CGTGTGTGGATGAG | | | | GGCCTGC[A/G]CATTCCCAA |
| | | | TCCATGCTGTT | | | | TACTCAGGCTCTGCTC |
| | 83 | RS464069 | GCCAGGCAGGGGCTGGTGGAG | | 194 | RS2229828 | CATAAGACCTACGACCCCAC |
| | | | GTGCA[C/G]GGCCTGGAGGAAC | | | | CTACTC[C/T]GACTTCTGCCA |
| | | | ACAGAGCCCAGC | | | | GTTCCGGCCTCCAG |
| | 84 | RS463379 | AGGAGAGGACGTTTGCGCGATT | | 195 | RS2228570 | TGGCCTGCTTGCTGTTCTTA |
| | | | CTCC[C/G]CAGATCCAGTGTTTC | | | | CAGGGA[C/T]GGAGGCAAT |
| | | | CCGTCAGCCA | | | | GGCGGCCAGCACTTCC |
| | 85 | RS403636 | GGCTCGTGGCCCTGCGGGCGGA | | 196 | Rs2238136 | TGTGGGGGTGGGCCAGCCC |
| | | | TCTT[G/T]GGAAGAGCTTGTTCA | | | | AGCTTAG[A/G]TTATCTTGG |
| | | | CACTCACCTA | | | | CTCATTGTCCACTAGT |
| | 86 | RS2617605 | TCGAGGCAGGGCCACCGGGGA | DBI | 197 | RS3091405 | TCTGTCCTCAGGCCAGGGCT |
| | | | CGTCC[A/G]AGAACATTGGTGA | | | | TCGCTG[A/C]AGCCCCGGCC |
| | | | TCCCTTCCCAGG | | | | ACTCCCTAGTGCCTG |
| | 87 | RS13189021 | AATGCAGGCGTGGGACAAGGC | | 198 | RS3769664 | TACGAACTCACTGTAAAACT |
| | | | AGCTC[C/T]GAGTCCTGCTCAAT | | | | CACCTT[C/T]GCCATAAGAC |
| | | | GGTTTTGTGAC | | | | CTTCTTCAACTAAGT |
| | 88 | RS6350 | GAGCTCATCCTTGTCAAGGAGC | | 199 | RS3769662 | ACAGAGTTTACGAACTCACT |
| | | | AGAA[C/T]GAGTGCAGCTCAC | | | | GTAAAA[C/T]TCACCTTCGC |
| | | | CAGCTCCACCC | | | | CATAAGACCTTCTTC |
| | 89 | RS2975223 | GTGGGGAGGGGTGCAGGGGAA | | 200 | RS956309 | GGAGAGAAAACAAAGTCAA |
| | | | GGAGG[A/G]GCAAACCAGAGT | | | | TGGGGCA[C/T]GTGTGGGA |
| | | | GTCTGTCTTGAGG | | | | AACCAGCCTGACCTGTG |
| | 90 | RS2963238 | AAACACGCTGCTGCTGGATCCA | | 201 | RS8192506 | TTACAGGGACTTCCAAGGA |
| | | | AATG[A/C]CAGAAGTCGCCCTG | | | | AGATGCC[A/G]TGAAAGCTT |
| | | | GCTGGGGCGGT | | | | ACATCAACAAAGTAGA |
| | 91 | RS11564752 | CTGCGCGCTGGTGCTCTGGGCA | GABRA6 | 202 | RS3811995 | TTGGGAAAGGAGAGTCTGA |
| | | | GGGC[G/T]GGGAGGCCGGGCG | | | | AGGGACA[A/G]TGCATGGT |
| | | | AGGACTCGCCAG | | | | CGGAGAGCAGTGACAAT |
| | 92 | RS2975226 | GGAGCCAGGACGCGAGGGCGA | | 203 | RS3219151 | AAATTGGAAATCTGTAACGC |
| | | | CCCCG[A/T]CGGCGGGAGGGCG | | | | AGCTTC[C/T]GTAAGCATGT |
| | | | GGGCGGGGCGGA | | | | GTGGGCAAAAAAGCA |
| HTR3B | 93 | RS3758987 | CCTTTACAGCCTTTACCTAAGGC | | 204 | RS6883829 | TTCTTTCCATCTGGCACCTAT |
| | | | AGT[A/G]CTCTTGCTGACATTCA | | | | TTATT[C/G]ACTATTTATGCA |
| | | | GGACACTAA | | | | TTCGTTGAATTAT |
| | 94 | RS2276307 | TTTGGCCTTCTCTCTTGGGCCAA | | 205 | RS3811991 | CTCTTTCACCATTGACAAAT |
| | | | GGA[A/G]TTTCTGCTCTATTGCA | | | | ATTTAT[G/T]GACGACTTAC |
| | | | TGTTCTCAT | | | | TTTCTATGTAAGGTC |
| | 95 | RS3782025 | GAGAGCTCCTTGGAGATGGAAT | GABRB3 | 206 | RS2912582 | CGTTCAGTTTAGTAAGCAAA |
| | | | AGGC[C/T]CCAAGGTTAGCCTG | | | | GGCTTC[C/T]TGGCTTCTCT |
| | | | TAATTGCCTCC | | | | GGTGATGGGGTTTGT |
| | 96 | RS1672717 | CCTTAGCACCTGTGTGTCTATCA | | 207 | RS2081648 | AGCTTACCATTTAAGTAGAA |
| | | | Ttc[C/T]gggcaggaaaacttgca | | | | CTGTTT[A/G]AGATGCTGGA |
| | | | caattaaa | | | | CATTCTAATACAATC |
| NOS3 | 97 | RS891512 | CTTCATCCGGGGGTAAGTGAGA | | 208 | RS1426217 | CCAAATCTGAAATTTACTTG |
| | | | TGGA[A/G]GACTTGGTGGGGA | | | | TCACTT[C/T]AGAGTTGTCTT |
| | | | GCTGCCCAGGGT | | | | TGAACGGAAAGATT |
| | 98 | RS1808593 | ACTATAGCTCCCAGAGCCAGAG | | 209 | RS754185 | TCTGTTGAGTGATAATCTTT |
| | | | CTGG[G/T]ATCAAACCGGCTGG | | | | CTCGCA[A/G]ATAACTCACA |
| | | | CCCTGTGGCTT | | | | ATATTTAAAAATTGT |
| | 99 | RS2070744 | ACCAGGGCATCAAGCTCTTCCCT | | 210 | RS890317 | AAGAACTCTTCCATGATTGA |
| | | | GGC[C/T]GGCTGACCCTGCCTCA | | | | AATGGT[A/C]GCACATGGA |
| | | | GCCCTAGTC | | | | ATAACATCGATAAGTT |
| | 100 | RS3918226 | AGGGTGGGGGTGGAGGCACTG | | 211 | RS981778 | ACAGCAGGTTGGAGCACAG |
| | | | GAAGG[C/T]AGCTTCCTGCTCTT | | | | GGCCTAA[A/G]TGGGAGGC |
| | | | TTGTGTCCCCC | | | | CAGGGAGGTGGGCAGAG |
| | 101 | RS7830 | GACTCCCTTCAGGCAGTCCTTTA | | 212 | RS2059574 | ATTGCTGATTTTCAGGCAAA |
| | | | GTC[A/C]CCAGCCTCACCTTTGC | | | | CTATGT[A/T]ACATGGCTTTC |
| | | | TCTCAATGT | | | | AATGGGTGCTTGGC |
| PPARG | 102 | RS1801282 | AAACTCTGGGAGATTCTCCTATT | MTHFR | 213 | RS4846048 | GAAGCAGTTAGTTCTGACAC |
| | | | GAC[C/G]CAGAAAGCGATTCCT | | | | CAACAA[A/G]TGGTGATAA |
| | | | TCACTGATAC | | | | GAGGTTGATAGCCTAG |
| | 103 | RS2938392 | AGGATTTTCTTACATTTAAAGCA | | 214 | RS1801131 | GTGGGGGGAGGAGCTGACC |
| | | | GAA[C/T]GACACTACTGATACAC | | | | AGTGAAG[A/C]AAGTGTCTT |
| | | | AAAAGTAAA | | | | TGAAGTCTTTGTTCTT |
| | 104 | RS1175542 | GAGAAATCTTCGGAGGGCTCAC | | 215 | RS1801133 | CTTGAAGGAGAAGGTGTCT |
| | | | CAGC[A/G]TCACAAGTAGGTAG | | | | GCGGGAG[C/T]CGATTTCAT |
| | | | ACCAGAAGAGG | | | | CATCACGCAGCTTTTC |
| | 105 | RS17036314 | GTTTACAGACCTTGTCAGAGTTG | | 216 | RS2066470 | AGATGTTCCACCCCGGGCCT |
| | | | GTA[C/G]TAATTCCAGAATATAA | | | | GGACCC[C/T]GAGCGGCAT |
| | | | TCATTTCAA | | | | GAGA |
| | 106 | RS1805192 | TGGTTGACACAGAGATGCCATT | MLXIPL | 110 | RS3812316 | GACAAAAAGCAATTGAGGT |
| | | | CTGG[C/G]CCACCAACTTTGGG | (carbo- | | | CCAGGAG[C/G]TGCCGCCC |
| | | | ATCAGCTCCGT | hydrate | | | ACCCGGCTCCTCCTCTG |
| | | | | binding | | | |
| | | | | element) | | | |
| | 107 | RS4684847 | GATTTATTTAAATCATCTCTAATT | | 217 | RS17145738 | CAGGTAACTGACCCTTCACA |
| | | | CT[C/T]ACAACTCCGAAAAGATA | | | | CATTTA[C/T]GGTGCCCATCT |
| | | | AGAAAACA | | | | GACATTCATAGCAT |
| | 108 | RS709157 | GTTGGGGATCCAGTTGGCCTCA | VEGF | 218 | RS2010963 | GCGCGCGGGCGTGCGAGCA |
| | | | TTCT[A/G]AGCTGGCTGTGGATT | | | | GCGAAAG[C/G]GACAGGGG |
| | | | CACAGAAGAA | | | | CAAAGTGAGTGACCTGC |
| | 109 | RS709158 | AAGATACGGGGGAGGAAATTC | | 219 | RS833068 | AGACATGTCCCATTTGTGGG |
| | | | ACTGG[A/G]TTTTACAATATATT | | | | AACTGT[A/G]ACCCTTCCTG |
| | | | TTTCAAGGCAA | | | | TGTGAGCTGGAGGCA |
| ChREBP | 110 | RS3812316 | GACAAAAAGCAATTGAGGTCCA | | 220 | RS3025000 | AGACATGTCCCATTTGTGGG |
| | | | GGAG[C/G]TGCCGCCCACCCGG | | | | AACTGT[A/G]ACCCTTCCTG |
| | | | CTCCTCCTCTG | | | | TGTGAGCTGGAGGCA |
| | | | | | 221 | RS3025010 | ACATCCTGAGGTGTGTTCTC |
| | | | | | | | TTGGGC[C/T]TGGCAGGCAT |
| | | | | | | | GGAGAGCTCTGGTTC |
| | | | | | 222 | RS3025039 | AGCATTCCCGGGCGGGTGA |
| | | | | | | | CCCAGCA[C/T]GGTCCCTCT |
| | | | | | | | TGGAATTGGATTCGCC |
| | | | | | 223 | RS3025053 | ATCCTCTTCCTGCTCCCCTTC |
| | | | | | | | CTGGG[A/G]TGCAGCCTAA |
| | | | | | | | AAGGACCTATGTCCT |

A common class of experiments, known as a multiplexed assay or multiplexed biochemical experiment, comprises reacting a sample known or suspected to contain one more target analyte species with a set of “probe” molecules. Multiplexing allows two or more, often many more (e.g., 10, 50, 100, 1,000 or more), target analyte species to be probed simultaneously (i.e., in parallel). For example, in a gene expression assay, each species of target analyte, usually a nucleic acid (i.e., DNA or RNA) of known nucleotide sequence but whose presence in a particular sample is suspected but is not known with certainty, can be detected using a short probe nucleic acid (e.g., a synthetically produced oligonucleotide) having a nucleotide sequence at least a portion of which is sufficiently complementary to the target sequence in the particular target analyte to allow stable hybridization under the various assay conditions used (including hybridization and stringent washing conditions) so that probe:target hybrids can later be detected using a desired detection scheme. As those in the art appreciate, such assays can involve those wherein target analyte species are labeled (or not) with a detectable label or wherein the various target analyte-specific probe species are labeled (directly or indirectly) with any suitable label that can be detected by the detector used with the particular assay format (e.g., bead-based formats, gene arrays, etc.). Labels include fluorescent molecules.

For example, in many known DNA/genomic bead-based multiplex assays, each probe species includes a DNA molecule of a predetermined nucleotide sequence and length attached to an encoded or otherwise identifiable bead or particle. When a labeled “target” analyte (in this case, a detectably labeled (e.g., fluorescently labeled) DNA molecule containing a target nucleotide sequence) is mixed with the probes, segments of the labeled target analyte selectively bind to complementary segments of the DNA sequence of one of the bead-bound probe species. The probes are then spatially separated and examined for fluorescence. The beads that fluoresce indicate that molecules of the target analyte have attached or hybridized to complementary probe molecules on that bead. The DNA sequence of the target analyte can then be determined, as the complementary nucleotide sequence of the particular probe species hybridized to the labeled target is known, and identification of the encoded bead indicates which probe species was bound to that bead. In addition, in such assays the level of fluorescence is indicative of how many of the target molecules hybridized (or attached) to the probe molecules for a given bead. As is known, similar bead-based assays may be performed with any set of know and unknown molecules, analytes, or ligands.

In such bead-based assays, the bead-bound probes are allowed to mix with samples that may contain the target analytes without any specific spatial position; as such, such assays are commonly called “random bead assays”. In addition, because the bead-bound probes are free to move (usually in a liquid medium), the probe molecules and target analytes have a better opportunity to interact than in other assay techniques, such as in a conventional planar microarray assay format.

There are many bead/substrate types that can be used for tagging or otherwise uniquely identifying individual beads with attached probes. Known methods include using polystyrene latex spheres that are colored or fluorescently labeled. Other methods include using small plastic particles with a conventional bar code applied, or a small container having a solid support material and a radio-frequency (RF) tag. Still other bead-based approaches involve vary small encoded beads, particles, or substrates capable of providing a large number of unique codes (e.g., greater than 1 million codes) are known. See, e.g., U.S. Pat. No. 7,900,836.

In multiplex assays designed to simultaneously examine 2-25 or so different target analyte species, other assay formats can be adapted for use in the context of the invention. Indeed, any format suited for analysis of multiple genes, either simultaneously in one or more parallel reactions or in different reactions carried out in series or at different times, can readily be adapted for use in practicing the invention.

3. Methods of the Invention.

The present invention provides methods that depend on detecting identified RDS-associated polymorphisms in genes now or in the future linked with one or more RDS behaviors, any such gene being an “RDS-associated” gene. A “RDS-associated polymorphism” is a polymorphism that distinguishes a “normal” allele from an allele associated or correlated with an RDS behavior. Such polymorphisms are detected in samples that contain populations of nucleic acids. RDS-associated polymorphisms have been identified in at least the following genes: DRD1, DRD2, DRD3, DRD4, DRD5, DAT1, PPARG, CHREBP, FTO, TNF-alpha, MANEA, Leptin OB, PEMT, MOAA, MOAB, CRH, CRHEP, CRHR1, CRHR2, GAL, NPY, NPY1R, NPY2R, NPYY5R, ADIPOQ, STS, VDR, DBI, 5HTTIRP, GABRA2, GABRA3, GABBRA4, GABRA5, GABRB1, GABRB2, GABRB3, GABRD, GABRE, GARG2, GABRG2, GABRG3, GARBQ, SLC6A7, SLC6A11, SLC6A13, SLC32A1, GAD1, GAD2, DB1, MTHFR, VEGF, NOS3, HTR3B, SLC6A3, SLC6A4, COMT, DDC, OPRD1, OPRM1, OPRK1, ANKK1, HTR2A, HTR2C, HTRIA, HTR1B, HTR2A, HTR2B, HTR2C, HTR3A, HTR3B, ALDH1, ALDH2, CAT, CYP2E1, ADH1A, ALDH1B, ALDH1C, ADH4, ADH5, ADH6, ADH7, TPH1, TPH2, CNR1, CYP2E1, OPRKI, PDYN, PNOC, PRD1, OPRL1, PENK, POMC, GLA1, GLRA1, GLRB, GPHN, FAAH, CHRM1, CHRM2, CHRM3, CHRM4, CHRM5, CHRNA4, CHRNB2, ADRA1A, ADRA2B, ADRB2, SLC6A2, DRA2A, DRA2C, ARRB2, DBH, SCL18A2, TH, GR1K1, GRIN1, GRIN2A, GRIN2B, GRIN2C, GRM1, SLC6A4, ADCY7, AVPR1A, AVPRIB, CDK5RI, CREB1, CSNKIE, FEV, FOS, FOSL1, FOSL2, GSKK3B, JUN, MAPK1, MAPK3, MAPK14, MPD2, MGFB, NTRK2, NTSRI, NTSR2, PPP1R1B, PRKCE, BDNF, CART, CCK, CCKAR, CCKBR, CLOCK, HCRT, LEP, OXT, NR3C1, SLC29A1, and TAC1.

Any genotyping method can be adapted for practice of this invention. In many currently available genotyping methods, a PCR or other nucleic acid amplification step is used to increase the amount of a given target nucleic acid (or nucleic acid containing the target nucleotide sequence, e.g., a SNP) within a genomic sample by amplification of the target sequences, if any, in the genomic sample. Other amplification methods omit a nucleic acid amplification step and instead detect signals from fewer numbers of target molecules, typically by another suitable form of signal amplification, e.g., by incorporation affinity groups into probe molecules that can subsequently be contacted with labeled partner molecules.

The present invention preferably utilizes solution hybridization between target and probe nucleic acids, although embodiments where probe molecules are bound to, for example, microarrays, can also be used. These methods employ nucleotide polymorphism-specific probes, typically detection reagents comprised of detectably labeled oligonucleotides, as hybridization probes for target nucleic acid molecules. In general, a nucleic acid sample derived from a biological sample taken from a subject (or pooled from a population of subjects), is annealed to an oligonucleotide probe specific for a genetic locus of interest. For example, such a locus can be a SNP, where the nucleic acid sample is genomic DNA. In alternative embodiments, where, for example, the nucleic acid sample being assayed is RNA, the locus can be a splice site. In any event, the annealed probe:target nucleic acid hybrids are then separated from free (i.e., unhybridized) probe molecules. The labeled probe:target hybrids, if any, are then detected. Detection may be qualitative, semi-quantitative, or quantitative. In some embodiments, the probe:target hybrids are captured on high density addressable arrays. The detectable labels present on the cleaved hybrid molecules are then detected and analyzed to identify polymorphic sites within the specific target nucleic acid molecule of interest.

In preferred embodiments of the present invention, labeled oligonucleotides are used as RDS-associated, polymorphism-specific hybridization probes to target and detect polymorphic sequences. Such probes are typically labeled with markers (i.e., detectable or affinity labels) to detect hybridization with target nucleic acids at various steps of the process. As is known, polymorphism-specific oligonucleotide probes can be designed to correspond to any nucleic acid sequence, including regions known or suspected to contain a polymorphism. Many such clinically important SNPs are known, and over 200 known RDS-associated SNPs are listed in Table 2, above, although any RDS-associated gene known or suspected to contain a polymorphic site associated or correlated with an RDS behavior can be used as a target nucleic acid in the methods of the present invention.

SNP-specific probes include one or more distinguishable or detectable “markers”. A marker is typically a nucleotide residue that is incorporated into the probe during synthesis of the oligonucleotide that is covalently bound either to a detectable label (e.g., a fluorophore) or to an affinity group (e.g., biotin) that is labeled post-synthesis by contacting the affinity group with a labeled cognate binding partner. Detectable labels include luminescent compounds, chromophores, fluorescent compounds, radioactive isotopes or group containing them, and nonisotopic labels such as an enzyme or dye. Thus, a detectable label can be directly linked to a nucleotide or indirectly linked, e.g., by its presence on a partner molecule that binds to an affinity group directly linked to the nucleotide. For example, affinity groups or partner molecules that can be used include biotin, avidin, streptavidin, digoxygenin, haptens, and monoclonal and polyclonal primary or secondary antibodies. Those in the art can readily and without undue experimentation select appropriate RDS-associated polymorphisms, design, synthesize, and render distinguishable probe nucleic acid molecules and hybridized molecules that include such probes, as well as adapt and employ any suitable corresponding detector.

Before hybridization, target nucleic acids are prepared. Target nucleic acids, including genomic DNA, cDNA, and RNA, can routinely be prepared from a biological sample obtained from a patient, including whole blood, plasma, serum, skin, saliva, urine, lymph fluid, cells obtained from biopsies, and cultured cells. Methods for preparing nucleic acids from such sources are well known in the art (see, e.g., Sambrook et al., 1989, Molecular Cloning, A Laboratory Manual, 2d Ed., Cold Spring Harbor Laboratory Press, Cold Spring Harbor, N.Y.; Ausubel et al., eds., in the Current Protocols in Molecular Biology series of laboratory technique manuals, 1987-1994 Current Protocols, 1994-1997 John Wiley and Sons, Inc). In many embodiments, the target nucleic acid is a fragment of genomic DNA. Target DNA may be prepared for hybridization by fragmenting it into a desired size range, for example, to an average length of 200-10,000 base pairs. Fragmentation can be achieved mechanically (e.g., by sonication-based shearing), chemically, or enzymatically to generate fragments of desired size.

For hybridization, the target nucleic acids and labeled probe molecules are then mixed under conditions that allow hybridization to occur. To optimize results, hybridization stringency can be adjusted, as is routine and well known in the art. For example, some well-known variables considered when adjusting the stringency of a particular solution hybridization reaction include salt concentration, melting temperature, inclusion of denaturants, and the type and length of nucleic acid to be hybridized (e.g., DNA, RNA, PNA, etc.).

In preferred embodiments, the methods of the invention employ multiplex SNP screening, for example, to screen nucleic acids derived from a biological sample obtained from a single subject for variations across a spectrum of RDS-associated (and perhaps other) SNPs. In such methods, a library of different SNP-specific, labeled oligonucleotides is used to probe a single DNA sample for the presence of RDS-associated SNPs. “Positive” and “negative” “control” probe molecules can also be included in the multiplex assay. Hybridizations may be performed in batch mode, whereby many probe species are annealed to target nucleic acids in a single mixture. Probe:target hybrids, if any, can then be separated and analyzed. In other embodiments, the multiplex SNP detection methods of the invention can be used to perform phenotype/genotype association analysis. In such embodiments, the target nucleic acids may comprise DNA derived from a population of individuals suffering from one or more RDS behaviors. Control samples from non-afflicted populations are also analyzed, and the results compared between the two populations.

In other embodiments, the methods of the invention are used to screen a number of individuals for at least one, and preferably two or more, RDS-associated SNPs. Such methods may be useful, for example, for diagnostic screening of large numbers of subjects for RDS predisposition, for RDS-related pharmacogenomics (i.e., to assess the likelihood of a patient's response to a particular RDS therapeutic modality), etc.

4. Oliqonucleotides.

The oligonucleotide probes used in the methods of the invention are often oligonucleotides ranging from 10 to about 100 nucleotides in length. In the preferred embodiments, probe species are approximately 14 to about 50 bases in length, preferably up to 45 nucleotides in length, and even more preferably from about 15 to about 40 bases in length. An oligonucleotide can be DNA or RNA or chimeric mixtures or derivatives or modified versions thereof, can be single-stranded, double-stranded, or partially double-stranded. Oligonucleotides can be modified at base moieties, sugar moieties, and/or along the molecules' backbone, or combination thereof. Examples of modified base moieties include 5-fluorouracil, 5-bromouracil, 5-chlorouracil, 5-iodouracil, hypoxanthine, xanthine, 4-acetylcytosine, 5-(carboxyhydroxylmethyl) uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil, beta-D-mannosylqueosine, 5′-methoxycarboxymethyluracil, 5-methoxyuracil, 2-methylthio-N6-isopentenyladenine, uracil-5-oxyacetic acid (v), pseudouracil, queosine, 2-thiocytosine, 5-methyl-2-thiouracil, 2-thiouracil, 4-thiouracil, 5-methyluracil, uracil-5-oxyacetic acid methylester, uracil-5-oxyacetic acid (v), 5-methyl-2-thiouracil, 3-(3-amino-3-N-2-carboxypropyl)uracil, and 2,6-diaminopurine. Examples of modified phosphate backbones include phosphorothioate, phosphorodithioate, phosphoramidothioate, phosphoramidate, phosphordiamidate, ethylphosphonate, methylphosphonate, and alkyl phosphotriester backbone modifications. Other examples are peptide nucleic acids (PNAs). Oligonucleotides can be synthesized using any suitable method known in the art, e.g., by use of an automated DNA synthesizer (such as are commercially available from Biosearch, Applied Biosystems, etc.) configured to perform standard phosphoramidite chemistry.

In general, oligonucleotides comprise a sequence of nucleic acids that is at least 70%, preferably 80%, more preferably 90%, and most preferably 100%, complementary to a target sequence of 10 or more contiguous nucleotides present in the target region of the target nucleic acid. Preferred target regions of a number of RDS-associated polymorphisms are listed in Table 2, above.

Once synthesized, probe molecules (e.g., oligonucleotides) are preferably labeled with one or more distinguishable or detectable “markers”, with it being understood that the choice of label(s) or marker(s) used will correspond to the detection scheme to be employed for a given assay format.

The probes of the present invention allow the formation of detectable nucleic acid hybrids made up of a probe molecule and a target nucleic acid molecule containing an RDS-associated polymorphism that has a nucleic acid sequence substantially complementary to the nucleotide sequence of the probe molecule. Probe:target hybrids are stable nucleic acid structures comprising a double-stranded, hydrogen-bonded region, preferably 10 to 100 base pairs in length. “Hybrids” include RNA:RNA, RNA:DNA, and DNA:DNA duplex molecules. The term “substantially complementary” means that the sequence of bases or nucleotides in the probe allows the probe to preferentially hybridize under stringent hybridization assay conditions to a target nucleic acid region, i.e., an RDS-associated polymorphism (e.g., an RDS-associated SNP) in an RDS-associated gene. Preferably, the probe has a region of at least 10 contiguous nucleotide bases that is complementary to the corresponding target region. More preferably, the probe has a region of at least about 12-15 contiguous nucleotide bases that are complementary to the corresponding target nucleic acid region of an RDS-associated polymorphism.

As those in the art will appreciate, the probe molecules (e.g., oligonucleotides) targeted to RDS-associated alleles provide for rapid, objective, and sensitive methods of detection and, if desired, quantitation of RDS-associated polymorphisms in a subject's genome, or in a population.

5. Kits.

The present invention also features kits containing at least one, and preferably 2-250 or more, probe species, each of which targets a different RDS-associated polymorphism. As described elsewhere herein, the different probe species in a kit of the invention target different RDS-associated alleles. The different probe species are preferably oligonucleotides. At least one, and preferably some, many, or all, of the RDS-associated polymorphisms targeted by the different probe species in a kit is located in an RDS-associated gene. At least one, and preferably some, any, or all of such genes are selected from the group consisting of DRD1, DRD2, DRD3, DRD4, DRD5, DAT1, PPARG, CHREBP, FTO, TNF-alpha, MANEA, Leptin OB, PEMT, MOAA, MOAB, CRH, CRHEP, CRHR1, CRHR2, GAL, NPY, NPY1R, NPY2R, NPYY5R, ADIPOQ, STS, VDR, DBI, 5HTTIRP, GABRA2, GABRA3, GABBRA4, GABRA5, GABRB1, GABRB2, GABRB3, GABRD, GABRE, GARG2, GABRG2, GABRG3, GARBQ, SLC6A7, SLC6A11, SLC6A13, SLC32A1, GAD1, GAD2, DB1, MTHFR, VEGF, NOS3, HTR3B, SLC6A3, SLC6A4, COMT, DDC, OPRD1, OPRM1, OPRK1, ANKK1, HTR2A, HTR2C, HTRIA, HTR1B, HTR2A, HTR2B, HTR2C, HTR3A, HTR3B, ALDH1, ALDH2, CAT, CYP2E1, ADH1A, ALDH1B, ALDH1C, ADH4, ADH5, ADH6, ADH7, TPH1, TPH2, CNR1, CYP2E1, OPRKI, PDYN, PNOC, PRD1, OPRL1, PENK, POMC, GLA1, GLRA1, GLRB, GPHN, FAAH, CHRM1, CHRM2, CHRM3, CHRM4, CHRM5, CHRNA4, CHRNB2, ADRA1A, ADRA2B, ADRB2, SLC6A2, DRA2A, DRA2C, ARRB2, DBH, SCL18A2, TH, GR1K1, GRIN1, GRIN2A, GRIN2B, GRIN2C, GRM1, SLC6A4, ADCY7, AVPR1A, AVPRIB, CDK5RI, CREB1, CSNKIE, FEV, FOS, FOSL1, FOSL2, GSKK3B, JUN, MAPK1, MAPK3, MAPK14, MPD2, MGFB, NTRK2, NTSRI, NTSR2, PPP1 R1 B, PRKCE, BDNF, CART, CCK, CCKAR, CCKBR, CLOCK, HCRT, LEP, OXT, NR3C1, SLC29A1, and TAC1. Those skilled in the art will appreciate that such probes can readily be incorporated into any suitable kit format now known in the art or later developed. In some embodiments, kits according to the invention contain all the necessary reagents to carry out the assay methods described herein. A kit may contain packaging and one or more containers containing the probe species included in the particular kit, a product insert including instructions on how to perform an assay, and other reagents (e.g., buffers and the like) that may be required to perform a multiplex assay.

The invention will be better understood by reference to the following Examples, which are intended to merely illustrate the best mode now known for practicing the invention. The scope of the invention is not to be considered limited thereto.

### EXAMPLES

### Example 1

### The Role of the DRD2 A1 Allele in Cocaine Dependence

Since the discovery of the double helix, explorations of brain function in terms of both physiology and behavioral traits have resulted in a plethora of studies linking these activities to neurotransmitter functions having a genetic basis. The mechanisms underlining gene expression and the potential impairments due to polygenic inheritance—and as such, predisposition to addiction and self-destructive behaviors—have been studied. Studies have shown that the prevalence of the DRD2 A1 allele in Cocaine dependent (CD) subjects (n=53) was 50.9%. It was significantly higher than either the 16.0% prevalence (P<10(−4)) in non-substance abusing controls (n=100) or the 30.9% prevalence (P<10(−2)) in population controls (n=265) wherein substance abusers were not excluded. Logistic regression analysis of CD subjects identified potent routes of cocaine use and the interaction of early deviant behaviors and parental alcoholism as significant risk factors associated with the DRD2 A1 allele. The cumulative number of these risk factors in CD subjects was positively and significantly (P<10⁻³) related to DRD2 A1 allelic prevalence. The data showing a strong association of the minor alleles (A1 and B1) of the DRD2 with CD indicates that a gene, located on the q22-q23 region of chromosome 11, confers susceptibility to this drug disorder.

### Example 2

### The Brain Reward Cascade

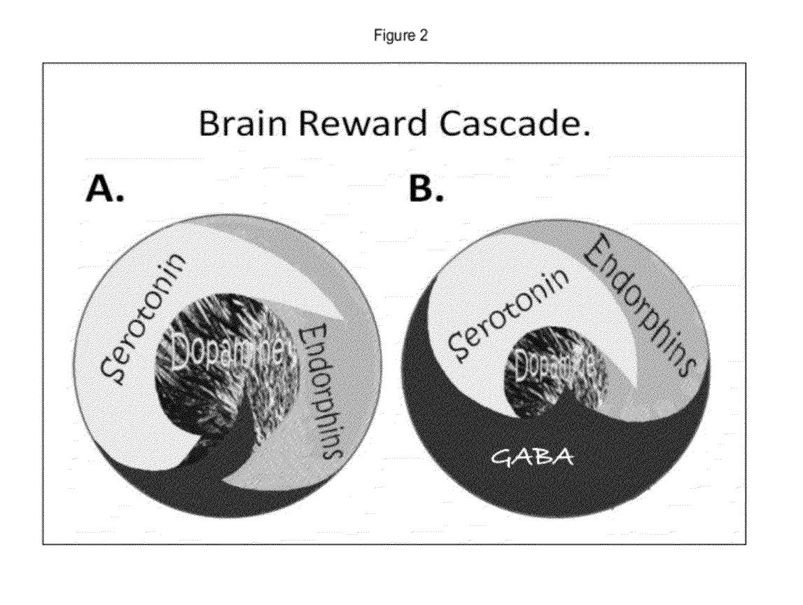

Over half a century of dedicated and rigorous scientific research on the mesolimbic system has provided insight into the addictive brain and the neurogenetic mechanisms involved in man's quest for happiness. In brief, the site of the brain where one experiences feelings of wellbeing is the mesolimbic system. This part of the brain has been termed the “reward center”. Chemical messages including serotonin, enkephalins, GABA, and dopamine (DA) work in concert to provide a net release of DA at the nucleous accumbens (NAc), a region in the mesolimbic system. It is well known that genes control the synthesis, vesicular storage, metabolism, receptor formation, and neurotransmitter catabolism. The polymorphic versions of these genes have certain variations that could lead to an impairment of the neurochemical events involved in the neuronal release of DA. The cascade of these neuronal events has been termed “Brain Reward Cascade”. See FIG. 2. A breakdown of this cascade ultimately leads to a dysregulation and dysfunction of DA. Since DA has been established as the “pleasure molecule” and the “anti-stress molecule,” any reduction in its function could lead to reward deficiency and resultant aberrant substance seeking behavior and a lack of wellness.

Humans are biologically predisposed to drink, eat, reproduce, and desire pleasurable experiences. Impairment in the mechanisms involved in these natural processes lead to multiple impulsive, compulsive, and addictive behaviors governed by genetic polymorphisms. While there are a plethora of genetic variations at the level of mesolimbic activity, polymorphisms of the serotonergic-2A receptor (5-HTT2a), serotonergic transporter (5HTTLPR), dopamine D2 receptor (DRD2), dopamine D4 receptor (DRD4), dopamine transporter (DAT1), and Catechol-o-methyl-transferase (COMT), and monoamine-oxidase (MOA) genes, as well as other genes, predispose individuals to excessive cravings and resultant aberrant behaviors.

An umbrella term to describe the common genetic antecedents of multiple impulsive, compulsive, and addictive behaviors is Reward Deficiency Syndrome (RDS). Individuals possessing a paucity of serotonergic and/or dopaminergic receptors and an increased rate of synaptic DA catabolism, due to high catabolic genotype of the COMT gene, or high MOA activity are predisposed to self-medicating with any substance or behavior that will activate DA release including alcohol, opiates, psychostimulants, nicotine, glucose, gambling, sex, and even excessive internet gaming, among others. Use of most drugs of abuse, including alcohol, is associated with release of dopamine in the mesocorticolimbic system or “reward pathway” of the brain. Activation of this dopaminergic system induces feelings of reward and pleasure. However, reduced activity of the dopamine system (hypodopaminergic functioning) can trigger drug-seeking behavior. Variant alleles can induce hypodopaminergic functioning through reduced dopamine receptor density, blunted response to dopamine, or enhanced dopamine catabolism in the reward pathway. Cessation of chronic drug use induces a hypodopaminergic state that prompts drug-seeking behavior in an attempt to address the withdrawal-induced state.

Acute utilization of these substances can induce a feeling of wellbeing. But, unfortunately sustained and prolonged abuse leads to a toxic pseudo feeling of well being resulting in tolerance and disease or discomfort. Thus, low DA receptors due to carrying the DRD2 A1 allelic genotype results in excessive cravings and consequential behavior, whereas normal or high DA receptors results in low craving induced behavior. In terms of preventing substance abuse, or excessive glucose craving, one goal is to induce a proliferation of DA D2 receptors in genetically prone individuals. Experiments in vitro have shown that constant stimulation of the DA receptor system via a known D2 agonist in low doses results in significant proliferation of D2 receptors in spite of genetic antecedents. In essence, D2 receptor stimulation signals negative feedback mechanisms in the mesolimbic system to induce mRNA expression causing proliferation of D2 receptors. This molecular finding serves as the basis to naturally induce DA release to also cause the same induction of D2-directed mRNA and thus proliferation of D2 receptors in the human. This proliferation of D2 receptors in turn, will induce the attenuation of craving behavior. In fact this has been proven with work showing DNA-directed over-expression (a form of gene therapy) of the DRD2 receptors and significant reduction in both alcohol and cocaine craving-induced behavior in animals.

These observations are the basis for the development of a functional hypothesis of drug-seeking and drug use. The hypothesis is that the presence of a hypodopaminergic state, regardless of the source, is a primary cause of drug-seeking behavior. Thus, genetic polymorphisms that induce hypodopaminergic functioning may be the causal mechanism of a genetic predisposition to chronic drug use and relapse. Finally, utilizing the long term dopaminergic activation approach will ultimately lead to a common safe and effective modality to treat RDS behaviors including Substance Use Disorders (SUD), Attention Deficit Hyperactivity Disorder (ADHD), and obesity among other reward deficient aberrant behaviors.

Support for the impulsive nature of individuals possessing dopaminergic gene variants is derived from a number of important studies illustrating the genetic risk for drug-seeking behaviors based on association and linkage studies implicating these alleles as risk antecedents having impact in the mesocorticolimbic system.

FIG. 2 shows two schematic representations. (A) represents the normal physiologic state of the neurotransmitter interaction at the mesolimbic region of the brain. Briefly, serotonin in the hypothalamus stimulates neuronal projections of methionine enkephalin in the hypothalamus that, in turn, inhibits the release of GABA in the substania nigra, thereby allowing for the normal amount of Dopamine to be released at the Nucleus Accumbens (NAc; reward site of the brain). (B) Represents hypodopaminergic function of the mesolimbic region of the brain. The hypodopaminergic state is due to gene polymorphisms as well as environmental elements, including both stress and neurotoxicity from aberrant abuse of psychoactive drugs (i.e. alcohol, heroin, cocaine etc). Genetic variables include serotonergic genes (serotonergic receptors [5HT2a]; serotonin transporter 5HTIPR); endorphinergic genes (the mu OPRM1 gene; proenkephalin (PENK); PENK polymorphic 3′ UTR dinucleotide (CA) repeats}; GABergic genes (GABRB3); and dopaminergic genes (including ANKKI Taq A; DRD2 C957T, DRD4 7R, COMT Val/met substitution, MAO-A uVNTR, and SLC6A3 9 or 10R). Any of these genetic and or environmental impairments could result in reduced release of dopamine and or reduced number of dopaminergic receptors.

### Example 3

### The RDS Endotype

In doing association studies that require a representative control sample for a single RDS psychiatric diagnosis or for potential subsets of RDS, one limitation relates to controls poorly screened for multiple RDS behaviors and other related psychiatric disorders. Missing behaviors that are part of the RDS subset may be the reason for spurious results when genotyping for single subsets of RDS behaviors. For example, an individual may not drink alcohol or use drugs but may have other RDS behaviors such as overeating or intensive video-gaming. In support of this, a very strong association of the dopamine D2 receptor A1 allele (100%) was found in one family studied, Family A. In addition, every individual in another family, Family B, also had at least one dopaminergic high risk allele (100%) (48% carried the DRD2 A1 allele). Moreover, in Family B only three adult individuals exhibited no addictive behavior. When compared to results in which 55 RDS subjects carried the DRD2 A1 allele at a frequency of 78.2% and the results of a study in which 597 severe alcoholics carried the A1 allele at a frequency of 49.3%, there was a significant difference between these two groups (X²=16.9, p<0.001). This demonstrated that the A1 allele's prevalence increases with multiple RDS behaviors. The results from the experiments show that multifaceted non-specific RDS behaviors should be considered as the true “reward” phenotype (endophenotype) instead of a single subset RDS behavior such as alcoholism.

### Example 4

### Certain RDS-Associated Genes and Polymorphisms

This example describes several preferred RDS-associated genes and RDS-associated polymorphisms.

### 1. D2 Dopamine Receptor Gene (DRD2)

The dopamine D2 receptor gene (DRD2) first associated with severe alcoholism is the most widely studied gene in psychiatric genetics. The Taq1 A is a single nucleotide polymorphism (SNP rs: 1800497) originally thought to be located in the 3′-untranslated region of the DRD2 but has since been shown to be located within exon 8 of an adjacent gene, the ankyrin repeat and kinase domain containing 1 (ANKK1). Importantly, while there may be distinct differences in function, the mis-location of the Taq1 A allele may be attributable to the ANKKI and the DRD2 being on the same haplotype or the ANKKI being involved in reward processing through a signal transduction pathway. The ANKKI and the DRD2 gene polymorphisms may have distinct, different actions with regard to brain function. Presence of the A1⁺ genotype (A1/A1, A1/A2)compared to the A⁻ genotype (A2/A2), is associated with reduced receptor density. This reduction causes hypodopaminergic functioning in the dopamine reward pathway. Other DRD2 polymorphisms such as the C (57T, A SNP (rs: 6277) at exon 7 also associates with a number of RDS behaviors including drug use. Compared to the T⁻ genotype (C/C), the T⁺genotype (T/T, T/C) is associated with reduced translation of DRD2 mRNA and diminished DRD2 mRNA, leading to reduced DRD2 density and a predisposition to alcohol dependence. The Taq1 A allele is a predictive risk allele.

More recently, the DRD2 haplotypes I-C-G-A2 and I-C-A-A1 have been found to occurr with a higher frequency in alcoholics [P=0.026, odds ratio (OR): 1.340; P=0.010, OR: 1.521, respectively]. The rare haplotype I-C-A-A2 occurred less often in alcoholics (P=0.010, OR: 0.507), and was also less often transmitted from parents to their affected children (1 vs. 7). Among the subgroups, I-C-G-A2 and I-C-A-A1 had a higher frequency in Cloninger 1 alcoholics (P=0.083 and 0.001, OR: 1.917, respectively) and in alcoholics with a positive family history (P=0.031, OR: 1.478; P=0.073, respectively). Cloninger 2 alcoholics had a higher frequency of the rare haplotype D-T-A-A2 (P<0.001, OR: 4.614) always compared with controls. In patients with positive family history, haplotype I-C-A-A2 (P=0.004, OR: 0.209) and in Cloninger 1 alcoholics, haplotype I-T-A-A1 (P=0.045 OR: 0.460) was less often present, confirming that haplotypes, which are supposed to induce a low DRD2 expression, are associated with alcohol dependence. Furthermore, supposedly high-expressing haplotypes weakened or neutralized the action of low-expressing haplotypes.

### 2. D4 Dopamine Receptor Gene (DRD4)

There is evidence that the length of the D4 dopamine receptor (DRD4) exon 3 variable number of tandem repeats (VNTR) affects DRD4 functioning by modulating the expression and efficiency of maturation of the receptor. The 7 repeat (7R) VNTR requires significantly higher amounts of dopamine to produce a response of the same magnitude as other size VNTRs. This reduced sensitivity or “dopamine resistance” leads to hypodopaminergic functioning. Thus 7R VNTR has been associated with substance-seeking behavior. Survival analysis has revealed that by 25 years of age 76% of subjects with a DRD4 7-repeat allele have significantly more persistent ADHD compared with 66% of subjects without the risk allele. In contrast, there were no significant associations between the course of ADHD and the DAT1 10-repeat allele (P=0.94) and 5HTTLPR long allele, suggesting that the DRD4 7-repeat allele is associated with a more persistent course of ADHD. This is consistent with the finding of the presence of the 7R DAT genotype in the heroin addict. Moreover, in a study evaluating the role of dopamine D4 receptor (DRD4) exon 3 polymorphisms (48 bp VNTR) in the pathogenesis of alcoholism, significant differences in the short alleles (2-5 VNTR) frequencies were found between controls and patients with a history of delirium tremors and/or alcohol seizures (p=0.043). A trend was also observed in the higher frequency of short alleles amongst individuals with an early age of onset of alcoholism (p=0.063). These results indicate that inherited short variants of DRD4 alleles (3R) may play a role in pathogenesis of alcohol dependence and carriers of the 4R may have a protective effect for alcoholism risk behaviors. It is of further note that the DRD4 7-repeat allele is significantly over-represented in the opioid-dependent cohort and confers a relative risk of 2.46.

### 3. Dopamine Transporter Gene (DAT1)

The dopamine transporter protein regulates dopamine-mediated neurotransmission by rapidly accumulating dopamine that has been released into the synapse. The dopamine transporter gene (SLC6A3 or DAT1) is localized to chromosome 5p15.3. Moreover, within 3′ non-coding region of DAT1 lies a VNTR polymorphism. There are two important alleles that may independently increase risk for RDS behaviors. The 9 repeat (9R) VNTR has been shown to influence gene expression and to augment transcription of the dopamine transporter protein, resulting in an enhanced clearance of synaptic dopamine, yielding reduced levels of dopamine to activate postsynaptic neurons. Presence of the 9R VNTR has also been linked to Substance Use Disorder (SUD). Moreover, in terms of RDS behaviors, tandem repeats of the dopamine transporter gene (DAT) have been associated with high risk for ADHD in children and in adults alike. The 10-repeat allele is significant for hyperactivity-impulsivity (HI) symptoms.

### 4. Catechol-O-Methyltransferase (COMT)

Catechol-O-methyltransferase (COMT) is an enzyme involved in the metabolism of dopamine, adrenaline, and noradrenaline. The Val158Met COMT gene polymorphism is associated with a variability of COMT activity and alcoholism. Interestingly, one of the subjects genotyped in the studies described in this example and who battles with heroin as an addiction while carrying the DRD2 A1 allele, also carried the low enzyme COMT activity genotype (A/A). No differences in genotype and allele frequencies of 158 val/met COMT gene polymorphism were observed between heroin-dependent subjects and normal controls (genotype-wise: chi-square=1.67, P=0.43; allele-wise: chi-square=1.23, P=0.27). No differences in genotype and allele frequencies of 900 Ins C/Del C polymorphism of the COMT gene were observed between heroin-dependent subjects and normal controls (genotype-wise: chi-square=3.73, P=0.16; allele-wise: chi-square=0.76, P=0.38). Also, the A allele of the val/met polymorphisms (−287 A/G) was found to be much higher in heroin addicts than controls. Faster metabolism results in reduced dopamine availability at the synapse, which reduces postsynaptic activation, inducing hypodopaminergic functioning.

### 5. Monoamine-Oxidase A

Monoamine oxidase-A (MAOA) is a mitochondrial enzyme that degrades the neurotransmitters serotonin, norepinephrine, and dopamine. This system is involved with both psychological and physical functioning. The gene that encodes MAOA is found on the X chromosome and contains a polymorphism (MAOA-uVNTR) located 1.2 kb upstream of the MAOA coding sequences. In this polymorphism, consisting of a 30-base pair repeated sequence, six allele variants containing either 2-, 3-, 3.5-, 4-, 5-, or 6-repeat copies have been identified. Functional studies indicate that certain alleles may confer lower transcriptional efficiency than others. The 3-repeat variant conveys lower efficiency, whereas 3.5- and 4-repeat alleles result in higher efficiency. The 3- and 4-repeat alleles are the most common, and to date there is less consensus regarding the transcriptional efficiency of the other less commonly occurring alleles (e.g., 2-, 5-, and 6-repeat). The primary role of MAOA in regulating monoamine turnover, and hence ultimately influencing levels of norepinephrine, dopamine, and serotonin, indicates that its gene is a highly plausible candidate for affecting individual differences in the manifestation of psychological traits and psychiatric disorders. Indeed, recent evidence indicates that the MAOA gene may be associated with depression and stress.

Low MAO activity and the neurotransmitter dopamine are two important factors in the development of alcohol dependence. MAO is an important enzyme associated with the metabolism of biogenic amines. The genetic variant of the DRD2 gene is associated with the anxiety, depression (ANX/DEP) ALC phenotype, and the genetic variant of the MAOA gene is associated with ALC. Subjects carrying the MAOA 3-repeat allele and genotype A1/A1 of the DRD2 were 3.48 times (95% confidence interval=1.47-8.25) more likely to be ANX/DEP than the subjects carrying the MAOA 3-repeat allele and DRD2 A2/A2 genotype. The MAOA gene may modify the association between the DRD2 gene and ANX/DEP ALC phenotype.

### 6. Serotonin Transporter Gene

The human serotonin (5-hydroxytryptamine) transporter, encoded by the SLC6A4 gene on chromosome 17q11.1-q12, is the cellular reuptake site for serotonin and a site of action for several drugs with central nervous system effects, including both therapeutic agents (e.g. antidepressants) and drugs of abuse (e.g., cocaine). It is known that the serotonin transporter plays an important role in the metabolic cycle of a broad range of antidepressants, antipsychotics, anxiolytics, antiemetics, and anti-migraine drugs. An excess of −1438G and 5-HTTLPR L carriers has been found in alcoholic patients in comparison to a heroin dependent group (OR (95% CI)=1.98 (1.13-3.45) and 1.92 (1.07-3.44), respectively). The A-1438G and 5-HTTLPR polymorphisms also interact in distinguishing alcohol from heroin dependent patients (df)=10.21 (4), p=0.037). The association of −1438A/G with alcohol dependence was especially pronounced in the presence of 5-HTTLPR S/S, less evident with 5-HTTLPR L/S, and not present with 5-HTTLPR L/L. SCL6A4 polymorphism haplotypes were similarly distributed in all three groups. Moreover, G allele carriers for rs1042173 have been found to be associated with significantly lower drinking intensity (p=0.0034) compared to T-allele homozygotes. In HeLa cell cultures, the cells transfected with G allele showed a significantly higher mRNA and protein levels than the T allele-transfected cells. These findings indicate that the allelic variations of rs1042173 affect drinking intensity in alcoholics by altering serotonin transporter expression levels.

### Example 5

### Multiplex Analysis and GARS

1. Introduction.

There is a need to classify patients at genetic risk for drug seeking behavior prior to or upon entry to residential and or non-residential chemical dependency programs. Instead of continuing to evaluate single gene associations to predict future drug abuse, the methods of the invention concerns evaluating multiple genes involved in the brain reward cascade and hypodopaminergic. As described in this example, such methods employ RDS-associated gene panels to stratify or classify patients entering a treatment facility as having low, moderate, or high genetic predictive risk based on a number of now known and/or later discovered RDS risk alleles. The inventors developed a Genetic Addiction Risk Score (GARS) for this purpose. This example describes genetic studies for seven RDS-associated alleles for six candidate genes in a patient population (n=26) of recovering poly-drug abusers.

To determine RDS risk severity for each of these 26 patients, the percentage of prevalence of the risk alleles was calculated and a severity score based on the percentage of these alleles present in a given patient was developed. Subjects carry the following risk alleles: DRD2=A1; SLC6A3 (DAT)=10R; DRD4=3R or 7R; 5HTTIRP=L or L_{A;} MAO=3R; and COMT=G. As depicted in Tables 5 and 6, below, Low Severity (LS)=1-36%, Moderate Severity=37-50%, and High Severity (HS)=51-100%, scores were assigned. Two distinct ethnic populations among the 26 patients were studied. Group 1 consisted of 16 male Caucasian psycho-stimulant addicts and Group 2 consisted of 10 Chinese heroin-addicted males. Based on this analysis, the 16 Caucasian subjects had at least one risk allele, or 100%. Out of these 16 subjects, 50% (8) were HS, 31% (5) were MS, and 19% (3) were LS. These scores were then converted to a fraction and represented as a Genetic Addiction Risk Score (GARS), whereby it was determined that the average GARS was: 0.28 low severity, 0.44 moderate severity, and 0.58 high severity, respectively. Therefore, using this approach it was found that 81% of the patients were at moderate to high risk for addictive behavior. Of particular interest was the discovery that 56% of the subjects carried the DRD2 A1 allele (9/16).

Out of the nine Chinese heroin addicts (one of whom was genotyped) (Group 2), it was found that 11% (1) were HS, 56% (5) were MS, and 33% (3) were LS. These scores were then converted to a fraction and represented as GARS, whereby the average GARS was found to be: 0.28 Low Severity; 0.43 moderate severity; and 0.54 high severity, respectively. Therefore, using GARS it was discovered that 67% of the Group 2 patients were at moderate to high risk for addictive behavior. As with Group 1, 56% of the Group 2 subjects carried the DRD2 A1 allele (5/9). Statistical analysis revealed that the two groups did not differ in terms of overall severity (67% vs. 81%) in these two distinct populations. Combining these two independent study populations reveals that subjects entering a residential treatment facility for poly-drug abuse carry at least one risk allele (100%). Moreover, 74% of the combined 25 subjects who were genotyped by SNP analysis had a moderate-to-high GARS.

### 2. Materials and Methods.

a. Subjects

The 16 patients of Group 1 were interviewed and evaluated for chemical dependence using a standard battery of diagnostic tests and questionnaires. The tests included the following: a drug history questionnaire; a physical assessment, urine drug tests; a breathalyzer; complete CBC blood test; and a symptom severity questionnaire. The patients were determined to be substance dependent according to Diagnostic and Statistical Manual (DSM-IV) criteria. All patients were residential in-patients enrolled in 30-90 day chemical dependence rehabilitation programs at either of two treatment centers in the U.S.

Table 3 shows the demographics of the 16 patients, including gender, race, age, and length of abstinence. The median age was 29.5±8.8 SD years. The population breakdown was as follows: 87.5% Caucasian and 12.5% Hispanic. The average number of months abstinent for the entire population was 9.5±23.3. There were 3 pure cocaine-only addicts; 4 cocaine crack addicts; and 9 cocaine plus other drugs of abuse (alcohol, opiates and marijuana).

Table 4 includes genotype data from a functional MRI (fMRI) study in China evaluating involving 10 heroin-addicted Chinese males with a median age of 33±7.6 SD years. Diagnosis of heroin dependence was also determined in this group using DSM-!V criteria and other behavioral instruments. The average number of months abstinent for the entire population was 16±7.9.

TABLE 3
Demographics of all Caucasian subjects combined

| | Median ± st. dev. | (min, max) | N (total = 16) |
|---|---|---|---|
| Age | 29.5 ± 8.80 | (19, 48) | 16 |
| Clean time (months) | 9.5 ± 23.33 | (2, 101) | 16 |
| Race = Caucasian | | | 14 |
| Race = Hispanic | | | 2 |
| Sex = Male | | | 16 |

| | |
|---|---|
| Primary Substance = Cocaine only | 3 |
| Primary Substance = Crack cocaine | 4 |
| Primary Substance = Cocaine + Other* | 9 |

TABLE 4
Demographics of all Chinese subjects combined*

| | Median ± st. dev. | (min, max) | N (total = 10) |
|---|---|---|---|
| Age | 33 ± 7.57 | (20, 44) | 10 |
| Clean time (months) | 16 ± 7.91 | (1, 24) | 10 |
| Race = Chinese | | | 10 |
| Sex = Male | | | 10 |

| | |
|---|---|
| Primary Substance = Heroin only | 10 |
| Primary Substance = Heroin + other | 0 |

*One sample was eliminated because genotyping could not be performed.

b. Genotypinq

Genotyping was performed as follows. Each patient was also genotyped for the following gene polymorphisms: MAOA-VNTR, 5HTTLPR, SLC6A3, DRD4, ANKKI, DRD2 TaqIA (rs1800497), and the COMT val¹⁵⁸met SNP (rs4680). Genotypes were scored independently by two investigators.

The dopamine transporter (DAT1, locus symbol SLC6A3, which maps to 5p15.3, contains a 40 base-pair Variable Number Tandem Repeat (VNTR) element consisting of 3-11 copies in the 3′ untranslated region (UTR) of the gene.

The dopamine D4 receptor (DRD4), which maps to 11p15.5, contains a 48 bp VNTR polymorphism in the third exon, which consists of 2-11 repeats.

Monoamine Oxidase A upstream VNTR (MAOA-uVNTR). The MAOA gene, which maps to Xp11.3-11.4, contains a 30 bp VNTR in the 5′ regulatory region of the gene that has been shown to affect expression. A genotype by environment interaction has been reported for this polymorphism.

Serotonin Transporter-Linked Polymorphic region (5HTTLPR). The serotonin transporter (5HTT, Locus Symbol SLC6A4), which maps to 17q11.1-17q12, contains a 43 bp insertion/deletion (ins/del) polymorphism in the 5′ regulatory region of the gene.

A SNP (rs25531, A/G) in the Long form of 5HTTLPR has functional significance: The more common L_{A} allele is associated with the reported higher basal activity, whereas the less common L_{G} allele has transcriptional activity no greater than the S. The SNP rs25531 is assayed by incubating the full length PCR product with the restriction endonuclease Mspl.

For all of the above VNTR and ins/del polymorphisms, PCR reactions contained approximately 20 ng of DNA, 10% DMSO, 1.8 mM MgCl2, 200 μM deoxynucleotides, with 7′-deaza-2′-deoxyGTP substituted for one half of the dGTP, 400 nM of appropriate forward and reverse amplification primers, and 1 unit of AmpliTaq Gold® polymerase, in a total volume of 20 μl. Amplification was performed using touchdown PCR. After amplification, an aliquot of PCR product was combined with loading buffer containing size standard (Genescan 1200 Liz) and analyzed with an ABI PRISM® 3130 Genetic Analyzer.

DRD2 TaqIA (rs1800497). The gene encoding the dopamine D2 receptor maps to 11q23, and contains a polymorphic TaqI restriction endonuclease site located within exon of the adjacent ANKKI gene that was originally thought to be located in the 3′ untranslated region of the gene. The A1 allele has been reported to reduce the amount of receptor protein. This SNP was assayed using a Taqman (5′Nuclease) assay.

COMT val¹⁵⁸met SNP (rs4680). The gene encoding COMT maps to 22q11.21, and codes for both the membrane-bound and soluble forms of the enzyme that metabolizes dopamine to 3-methoxy-4-hydroxyphenylethylamine. An A→G mutation results in a valine to methionine substitution at codons 158/108, respectively. This amino acid substitution has been associated with a four-fold reduction in enzymatic activity. The COMT SNP was assayed with a Taqman method.

c. Genetic Addiction Risk Score (GARS)

For genotyping, it was determined to assay seven risk alleles involved in six candidate genes in these patient populations. The alleles were: DRD2=A1; SLC6A3 (DAT)=10R; DRD4=3R or 7R; 5HTTIRP=L or L_{A;} MAO=3R; and COMT=G. To determine RDS severity in the 25 patients studied (one Chinese subject was eliminated from the analysis due to poor PCR amplification), the percentage of prevalence of the risk alleles was calculated and given an arbitrary severity score based on percentage of risk alleles present. In the tables, Low Severity (LS)=1-36%, Moderate Severity (MS)=37-50%, and High Severity (HS)=51-100%.

### 3. Results.

The resultant genotyping for Group 1 is shown in Table 5, below, and represents a total of 16 patients (Group 1) identified as addicts.

Based on this model 16 subjects tested have at least one risk allele or 100%. Out of the 16 subjects it was found that 50% (8) were HS, 31% (5) were MS, and 19% were LS (3 subjects). These scores were then converted to a fraction and then represented as a GARS, whereby the average GARS was found to be: 0.28 Low Severity; 0.44 Moderate Severity, and 0.58 High Severity, respectively. Therefore, using GARS it was found that 81% of the patients were at moderate to high risk for addictive behavior. Of particular interest was the finding that 56% of the subjects carried the DRD2 A1 allele (9/16) (see Table 5, below).

TABLE 5
Group 1 genotyping data for each Caucasian patient.

| | | | | | | | | Any risk | SEVERITY* |
|---|---|---|---|---|---|---|---|---|---|
| Subject | MAOAuVNTR | 5HTTLPR | 5HTTLPR | SLC6A3 | DRD4 | DRD2 | COMT | allele | GARS |
| 1 | 3R | S/L | S/L_{G} | 9R/10R | 4R/4R | A1/A2 | G/G | POSITIVE | 0.46-MS |
| 2 | 3R | S/L | S/L_{A} | 10R/10R | 4R/7R | A2/A2 | G/G | POSITIVE | 0.62-HS |
| 3 | 3R | L/L | L_{A}/L_{G} | 9R/9R | 3R/4R | A1/A2 | A/G | POSITIVE | 0.57-HS |
| 4 | 4R | S/L | S/L_{A} | 10R/10R | 3R/7R | A2/A2 | G/G | POSITIVE | 0.46-MS |
| 5 | 4R | L/L | L_{A}/L_{A} | 10R/10R | 4R/7R | A2/A2 | A/G | POSITIVE | 0.62-HS |
| 6 | 3R | S/S | S/S | 9R/10R | 4R/7R | A2/A2 | A/G | POSITIVE | 0.30-LS |
| 7 | 4R | S/L | S/L_{G} | 10R/10R | 4R/4R | A1/A1 | A/A | POSITIVE | 0.38-MS |
| 8 | 4R | S/L | S/L_{A} | 9R/10R | 3R/4R | A2/A2 | A/A | POSITIVE | 0.23-LS |
| 9 | 3R | L/L | L_{A}/L_{A} | 9R/9R | 4R/7R | A2/A2 | A/G | POSITIVE | 0.54-HS |
| 10 | 4R | L/L | L_{A}/L_{A} | 9R/10R | 4R/4R | A2/A2 | G/G | POSITIVE | 0.54-HS |
| 11 | 3R | S/L | S/L_{A} | 9R/10R | 4R/4R | A1/A2 | G/G | POSITIVE | 0.54-HS |
| 12 | 4R | L/L | L_{A}/L_{A} | 9R/10R | 4R/4R | A1/A2 | A/G | POSITIVE | 0.54-HS |
| 13 | 4R | S/L | S/L_{A} | 10R/10R | 4R/4R | A1/A2 | A/G | POSITIVE | 0.46-MS |
| 14 | 4R | S/S | S/S | 9R/10R | 4R/4R | A1/A2 | G/G | POSITIVE | 0.30-LS |
| 15 | 3R | L/L | L_{A}/L_{A} | 10R/10R | 4R/4R | A1/A2 | A/G | POSITIVE | 0.69-HS |
| 16 | 4R | S/L | S/L_{A} | 10R/10R | 4R/7R | A1/A2 | A/A | POSITIVE | 0.46-MS |

Moreover, data obtained from a fMRI study in China in heroin-addicted males (see demographic Table 4, above) show similar results (see Table 6, below). Based on this analysis, the 9 subjects tested (Group 2) had at least one risk allele or 100%. Out of the 9 subjects, 11% (1) were HS, 56% (5) were MS, and 33% were LS (3 subjects). These scores were then converted to a fraction and represented as a GARS, whereby it was found that the average GARS was: 0.28 Low Severity; 0.43 Moderate Severity, and 0.54 were High Severity. Therefore, using GARS it was determined that 67% of the Group 2 patients were at moderate-to-high risk for addictive behavior. Of particular interest was the finding that that 56% of the Group 2 subjects carried the DRD2 A1 allele (5/9) [see Table 4]. Statistical analysis revealed that Groups 1 and 2 did not differ in terms of overall severity (67 vs. 81%). Using the z-test of proportions, the resulting z=0.79 with p=0.432.

Nevertheless, combining these two independent study populations (Groups 1 and 2) reveals that subjects entering a residential treatment facility for poly-drug abuse carry at least one risk allele (100%). Moreover, it was determined that 74% of the combined 25 subjects (Caucasian and Chinese) had a moderate-to-high GARS.

TABLE 6
Group 2 genotyping data for each Chinese patient.

| | | | | | | | | Any risk | SEVERITY* |
|---|---|---|---|---|---|---|---|---|---|
| Subject | MAOAuVNTR | 5HTTLPR | 5HTTLPR | SLC6A3 | DRD4 | DRD2 | COMT | allele | GARS |
| 1 | 4R | S/L | S/L_{A} | 10R/10R | 4R/4R | A2/A2 | A/A | POSITIVE | 0.30-LS |
| 2 | 3R | S/S | S/S | 10R/10R | 2R/4R | A1/A2 | GAG | POSITIVE | 0.38-MS |
| 3 | 4R | S/S | S/S | 10R/10R | 3R/4R | A1/A2 | G/G | POSITIVE | 0.46-MS |
| 4 | 3R | S/S | S/S | 10R/10R | 4R/6R | A2/A2 | G/G | POSITIVE | 0.38-MS |
| 5 | 4R | S/S | S/S | 10R/10R | 4R/4R | A1/A2 | A/G | POSITIVE | 0.30-LS |
| 6 | 3R | L/L | S/L_{G} | 10R/10R | 4R/4R | A1/A2 | ND | POSITIVE | 0.45-MS |
| 7 | 4R | L/L | L_{A}/L_{G} | 10R/10R | 4R/4R | A1/A2 | A/G | POSITIVE | 0.54-HS |
| 8 | 4R | S/S | S/S | 10R/10R | 4R/5R | A2/A2 | A/G | POSITIVE | 0.23-LS |
| 9 | 3R | S/L | S/L_{A} | 10R/10R | 2R/4R | A2/A2 | A/G | POSITIVE | 0.46-MS |

### 4. Discussion.

In terms of genotyping data it has been determined that when multiple RDS-associated genes are analyzed, such as the genes for serotonergic- 2A receptor (5-HTT2a), serotonergic transportor (5HTTLPR), (dopamine D2 receptor (DRD2), Dopamine D4 receptor (DRD4), Dopamine transporter (DAT1), Catechol-o-methyl -transferase (COMT), and monoamine-oxidase (MOA), 100% of all subjects carried at least one risk allele. To the inventors' knowledge this is the first reported attempt to stratify or classify addiction risk by incorporating an algorithm formulation that combines genotyping results for a number of RDS-associated risk alleles by pre-assigning an allele as a risk allele having predictive value for drug use. Previosuly, using Baysian statistics it was shown that the DRD2 A1 allele had a predictive value of 74.4% for all Reward Deficiency Syndrome (RDS). Here, the subjects studied in this investigation had multiple drug abuse relapses and presented to in-patient residential treatment programs. The finding that 75% of these individuals have moderate-to-high GARS, whereas only 25% had low GARS, indicates that pre-screening patients prior enrolling in a treatment program could be beneficial. Clinically, this will be important for understanding expectations of future success and the need for intensive treatment involving genomic solutions coupled with medical therapies, including bio-holistic therapies. It will also reduce patient quilt and denial.

The present study supports the understanding that identifying hypodopaminergic genotypes may be the best predictor of adult and adolescent drug abuse or other SUD behavior. These results are also consistent with a number of functional MRI studies that show that the hypodopaminergic DRD2 A1 genotype leads to blunted responses that can could lead to aberrant drug and/or food seeking behavior, while the hyperdopaminergic A2 genotype serves as a protective factor against the development of drug disorders.

A further strength of this study is that only used male subjects were used, as males with hypodopaminergic functioning are more likely to abuse drugs that stimulate the mesocorticallmbic system than those with normal dopaminergic functioning. In contrast, females living in a negative environment are at increased risk (possibly not due to their genotypes) for using more drugs and even more types of drug that increase their risk for SUD.

Another strength of this study is that it confirms the importance of the cumulative effect of multiple genotypes coding for hypodopaminergic functioning, regardless of their genomic location, as a predictive method of drug use in males. Moreover, it extends the current literature, by providing for the first time a simple method using genetic testing to classify risk behavior in male patients seeking in-patient residential treatment.

### 5. Conclusion.

The need to genetically test individuals, especially at entry into a residential or even non-residential chemical dependency program, has long been recognized. In this study, a high percentage (75%) of subjects were found to carry a moderate to high GARS, and 100% of individuals tested possesed at least one of the RDS risk alleles tested. It is of some interest that in the Group 2 population only rare DRD4 alleles such as 2R, 5R, and 6R were found. This study supports the inventors' understanding that hypodopaminergic state is due to gene polymorphisms, as well as environmental elements including both stress and neurotoxicity from aberrant abuse of psychoactive drugs (e.g., alcohol, heroin, cocaine etc). This study demonstrates that useful genetic variables include serotonergic genes (e.g., serotonergic receptors [5HT2a], serotonin transporter 5HTIPR, etc.), endorphinergic genes (e.g., mu OPRM1 gene, proenkephalin (PENK) [PENK polymorphic 3′ UTR dinucleotide (CA) repeats]), and GABergic genes (e.g., GABRB3) and dopaminergic genes (e.g., ANKKI Taq A; DRD2 C957T, DRD4 7R, COMT Val/met substation, MAO-A uVNTR, and SLC3 9 or 10R). Any of these genetic and/or environmental impairments could result in reduced release of dopamine and or reduced number of dopaminergic receptors. The use of GARS will have prevention and treatment benefits in those patients afflicted with genetic antecedents to RDS-seeking behaviors.

### Example 6

### A Representative RDS Gene Panel

This example, in Table 7, below, describes an RDS-associated gene/polymorphism panel that can be used in accordance with the invention.

TABLE 7
An RDS gene panel

| Gene | Significance | Comment |
|---|---|---|
| ALDH2 | P = 5 × 10⁻³⁷ | With alcoholism and alcohol-induced |
| | | medical diseases |
| ADH1B | P = 2 × 10⁻²¹ | With alcoholism and alcohol-induced |
| | | medical diseases |
| ADH1C | P = 4 × 10⁻³³ | With alcoholism and alcohol-induced |
| | | medical diseases |
| DRD2 | P = 1 × 10⁻⁸ | With alcohol and dug abuse |
| DRD4 | P = 1 × 10⁻² | With alcohol and drug abuse |
| SLC6A4 | P = 2 × 10⁻³ | With alcohol, heroin, cocaine, metham- |
| | | phetamine dependence |
| HTRIB | P = 5 × 10⁻¹ | With alcohol and drug abuse |
| HTRI2A | P = 5 × 10⁻¹ | With alcohol and drug abuse |
| TPH | P = 2 × 10⁻³ | With alcohol and drug abuse |
| MAOA | P = 9 × 10⁻⁵ | With alcohol and drug abuse |
| OPRD1 | P = 5 × 10⁻¹ | With alcohol and drug abuse |
| GABRG2 | P = 5 × 10⁻⁴ | With alcohol and drug abuse |
| GABRA2 | P = 7 × 10⁻⁴ | With alcohol and drug abuse |
| GABRA6 | P = 6 × 10⁻⁴ | With alcohol and drug abuse |
| COMT* | P = 5 × 10⁻¹ | With alcohol and drug abuse in Asians |
| DAT1 | P = 5 × 10⁻¹ | With alcohol and drug abuse in Asians |
| CNR1 | P = 5 × 10⁻¹ | With alcohol and drug abuse |
| CYP2E1* | P = 7 × 10⁻² | With alcohol LIVER DISEASE |

Although the invention has been described with reference to the above specification, it will be understood that modifications and variations are encompassed within the spirit and scope of the invention. Accordingly, the invention is limited only by the appended claims.

All of the articles, devices, compositions, kits, and methods described and claimed herein can be made and executed without undue experimentation in light of the present specification. While the articles, devices, compositions, kits, and methods of this invention have been described in terms of preferred embodiments, it will be apparent to those of skill in the art that variations may be applied to the articles, devices, compositions, kits, and methods and in the steps or in the sequence of steps of the methods described herein without departing from the spirit and scope of the invention as defined by the appended claims.

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A method of performing a genetic analysis related to Reward Deficiency Syndrome (RDS), comprising:
a. performing an allelic analysis on a biological sample from a subject to determine if the subject's genome contains at least two RDS-associated allele for a gene selected from the group consisting of DRD1, DRD2, DRD3, DRD4, DRD5, DAT1, PPARG, CHREBP, FTO, TNF-alpha, MANEA, Leptin OB, PEMT, MOAA, MOAB, CRH, CRHEP, CRHR1, CRHR2, GAL, NPY, NPY1R, NPY2R, NPYY5R, ADIPOQ, STS, VDR, DBI, 5HTTIRP, GABRA2, GABRA3, GABBRA4, GABRA5, GABRB1, GABRB2, GABRB3, GABRD, GABRE, GARG2, GABRG2, GABRG3, GARBQ, SLC6A7, SLC6A11, SLC6A13, SLC32A1, GAD1, GAD2, DB1, MTHFR, VEGF, NOS3, HTR3B, SLC6A3, SLC6A4, COMT, DDC, OPRD1, OPRM1, OPRK1, ANKK1, HTR2A, HTR2C, HTRIA, HTR1B, HTR2A, HTR2B, HTR2C, HTR3A, HTR3B, ALDH1, ALDH2, CAT, CYP2E1, ADH1A, ALDH1B, ALDH1C, ADH4, ADH5, ADH6, ADH7, TPH1, TPH2, CNR1, CYP2E1, OPRKI, PDYN, PNOC, PRD1, OPRL1, PENK, POMC, GLA1, GLRA1, GLRB, GPHN, FAAH, CHRM1, CHRM2, CHRM3, CHRM4, CHRM5, CHRNA4, CHRNB2, ADRA1A, ADRA2B, ADRB2, SLC6A4, DRA2A, DRA2C, ARRB2, DBH, SCL18A2, TH, GR1K1, GRIN1, GRIN2A, GRIN2B, GRIN2C, GRM1, SLC6A4, ADCY7, AVPR1A, AVPRIB, CDK5RI, CREB1, CSNKIE, FEV, FOS, FOSL1, FOSL2, GSKK3B, JUN, MAPK1, MAPK3, MAPK14, MPD2, MGFB, NTRK2, NTSRI, NTSR2, PPP1R1B, PRKCE, BDNF, CART, CCK, CCKAR, CCKBR, CLOCK, HCRT, LEP, OXT, NR3C1, SLC29A1, and TAC1, thereby performing a genetic analysis related to Reward Deficiency Syndrome (RDS); and, optionally,
b. determining a genetic addiction risk based on the results of the allelic analysis, wherein the genetic addiction risk takes into the account the presence of one or more of RDS-associated alleles among the genes analyzed; wherein the presence of at least one RDS-associated allele indicates a genetic addiction risk.

2. A method according to claim 1 wherein the allelic analysis analyzes whether the biological sample contains at least one one RDS-associated allele for a gene selected from among at least one of the following groups:
a. OPRMI, PRKI, PDYN, PNOC, PRD1, OPRL1, PENK, and POMC
b. GLA1, GLRA1, GLRB, and GPHN;
c. CNR1 and FAAH;
d. CHRM1, CHRM2, CHRM3, CHRM4, CHRM5, CHRNA4, and CHRNB2;
e. ADRA1A, ADRA2B, ADRB2, SLC6A2, DRA2A, DRA2C, ARRB2, and DBH;
f. GABRA2, GABRA3, GABBRA4, GABRA5, GABRB1, GABRB2, GABRB3, GABRD, GABRE, GARG2, GABRG3, GABRG3, GARBQ, SLC6A7, SLC6A11, SLC6A13, SLC32A1, GAD1, GAD2, DB1;
g. COMT, DDC, DRD1, DRD2, DRD3, DRD4, DRD5, SCL18A2, SLC6A3, and TH;
h. GR1K1, GRIN1, GRIN2A, GRIN2B, GRIN2C, and GRM1;
i. HTRIA, HTR1B, HTR2A, HTR2B, HTR2C, HTR2C, HTR3A, HTR3B, MAOA, MOAB, SLC6A4, TPH1, and TPH2;
j. ADCY7, AVPR1A, AVPRIB, CDK5RI, CREB1, CSNKIE, FEV, FOS, FOSL1, FOSL2, GSKK3B, JUN, MAPK1, MAPK3, MAPK14, MPD2, MGFB, NTRK2, NTSRI, NTSR2, PPP1R1B,and PRKCE;
k. ALDH1, ALDH2, CAT, CYP2E1, ADH1A, ADH1B, ADH1C, ADH4, ADH5, ADH6, and ADH7I;
l. CRH, CRHEP, CRHR1, CRHR2, GAL, NPY, NPY1R, NPY2R, and NPYY5R; and
m. BDNF, CART, CCK, CCKAR, CCKBR, CLOCK, HCRT, LEP, OXT, NR3C1, SLC29A1, TAC1;

3. A method according to claim 2 wherein the allelic analysis analyzes whether the biological sample contains at least one RDS-associated allele for a gene independently selected from among at least two of the groups (a)-(m).

4. A method according to claim 1 wherein the allelic analysis comprises analyzing whether the biological sample contains at 2-1,000 RDS-associated alleles.

5. A method according to claim 1 wherein the allelic analysis comprises analyzing whether the biological sample contains at least one RDS-associated allele for each of the following genes: OPRD1, CYP, and PENK.

6. A method according to claim 1 wherein the allelic analysis comprises analyzing whether the biological sample contains at least one RDS-associated allele for each of the following genes: DRD, SLC6A3, 5HTTIRP, MAOA, COMT, OPRD, GABRG2, PENK, and CYP.

7. A method according to claim 1 wherein the allelic analysis comprises analyzing whether the biological sample contains at least one RDS-associated allele for each of the following genes: ALDH2, DRD2, HTR2A, SLC6A4, MAOA, OPRD1, GABRG2, COMT, DAT1, CNR1, and CYP.

8. A method according to claim 1 wherein genetic addiction risk is determined by calculating a genetic addiction risk score derived from the allelic analysis wherein the presence of at least one of said RDS-associated alleles is indicative of a genetic risk for RDS.

9. A method according to claim 1 wherein genetic risk score is determined by analyzing the total number of RDS-associated alleles determined to be present in the sample and the total number of RDS-associated alleles analyzed.

10. A method according to claim 1 wherein the genetic risk score is qualitative or quantitative.

11. A kit, comprising at least two nucleic acid probe species, wherein each nucleic acid probe species optionally is an oligonucleotide species, and wherein each nucleic acid probe species targets a different RDS-associated allele, wherein at least one of the RDS-associated alleles is an allele for a gene selected from the group consisting of DRD1, DRD2, DRD3, DRD4, DRD5, DAT1, PPARG, CHREBP, FTO, TNF-alpha, MANEA, Leptin OB, PEMT, MOAA, MOAB, CRH, CRHEP, CRHR1, CRHR2, GAL, NPY, NPY1R, NPY2R, NPYY5R, ADIPOQ, STS, VDR, DBI, 5HTTIRP, GABRA2, GABRA3, GABBRA4, GABRA5, GABRB1, GABRB2, GABRB3, GABRD, GABRE, GARG2, GABRG2, GABRG3, GARBQ, SLC6A7, SLC6A11, SLC6A13, SLC32A1, GAD1, GAD2, DB1, MTHFR, VEGF, NOS3, HTR3B, SLC6A3, SLC6A4, COMT, DDC, OPRD1, OPRM1, OPRK1, ANKK1, HTR2A, HTR2C, HTRIA, HTR1B, HTR2A, HTR2B, HTR2C, HTR3A, HTR3B, ALDH1, ALDH2, CAT, CYP2E1, ADH1A, ALDH1B, ALDH1C, ADH4, ADH5, ADH6, ADH7, TPH1, TPH2, CNR1, CYP2E1, OPRKI, PDYN, PNOC, PRD1, OPRL1, PENK, POMC, GLA1, GLRA1, GLRB, GPHN, FAAH, CHRM1, CHRM2, CHRM3, CHRM4, CHRM5, CHRNA4, CHRNB2, ADRA1A, ADRA2B, ADRB2, SLC6A2, DRA2A, DRA2C, ARRB2, DBH, SCL18A2, TH, GR1K1, GRIN1, GRIN2, GRIN2B, GRIN2C, GRM1, SLC6A4, ADCY7, AVPR1A, AVPRIB, CDK5RI, CREB1, CSNKIE, FEV, FOS, FOSL1, FOSL2, GSKK3B, JUN, MAPK1, MAPK3, MAPK14, MPD2, MGFB, NTRK2, NTSRI, NTSR2, PPP1R1B, PRKCE, BDNF, CART, CCK, CCKAR, CCKBR, CLOCK, HCRT, LEP, OXT, NR3C1, SLC29A1, and TAC1.

12. A kit according to claim 11 wherein each nucleic acid probe species is labeled with a detectable label.

13. A kit according to claim 11 that comprises a plurality of detection reagent species, wherein each detection reagent species comprises a nucleic acid probe species, optionally is oligonucleotide species is coupled to a substrate, optionally a bead, wherein the nucleic acid probe species of a detection reagent species is unique to that detection reagent species and targets a RDS-associated allele for a gene selected from the group consisting of DRD1, DRD2, DRD3, DRD4, DRD5, DAT1, PPARG, CHREBP, FTO, TNF-alpha, MANEA, Leptin OB, PEMT, MOAA, MOAB, CRH, CRHEP, CRHR1, CRHR2, GAL, NPY, NPY1R, NPY2R, NPYY5R, ADIPOQ, STS, VDR, DBI, 5HTTIRP, GABRA2, GABRA3, GABBRA4, GABRA5, GABRB1, GABRB2, GABRB3, GABRD, GABRE, GARG2, GABRG2, GABRG3, GARBQ, SLC6A7, SLC6A11, SLC6A13, SLC32A1, GAD1, GAD2, DB1, MTHFR, VEGF, NOS3, HTR3B, SLC6A3, SLC6A4, COMT, DDC, OPRD1, OPRM1, OPRK1, ANKK1, HTR2A, HTR2C, HTRIA, HTR1B, HTR2A, HTR2B, HTR2C, HTR3A, HTR3B, ALDH1, ALDH2, CAT, CYP2E1, ADH1A, ALDH1B, ALDH1C, ADH4, ADH5, ADH6, ADH7, TPH1, TPH2, CNR1, CYP2E1, OPRKI, PDYN, PNOC, PRD1, OPRL1, PENK, POMC, GLA1, GLRA1, GLRB, GPHN, FAAH, CHRM1, CHRM2, CHRM3, CHRM4, CHRM5, CHRNA4, CHRNB2, ADRA1A, ADRA2B, ADRB2, SLC6A2, DRA2A, DRA2C, ARRB2, DBH, SCL18A2, TH, GR1K1, GRIN1, GRIN2a, GRIN2B, GRIN2C, GRM1, SLC6A4, ADCY7, AVPR1A, AVPRIB, CDK5RI, CREB1, CSNKIE, FEV, FOS, FOSL1, FOSL2, GSKK3B, JUN, MAPK1, MAPK3, MAPK14, MPD2, MGFB, NTRK2, , NTSRI, NTSR2, PPP1R1B, PRKCE, BDNF, CART, CCK, CCKAR, CCKBR, CLOCK, HCRT, LEP, OXT, NR3C1, SLC29A1, and TAC1.


SEQUENCE LISTING (224 sequences)

SEQ ID NO: 1 - DNA, 52 bp, Homo sapiens
ctggacgtccagctgggcgcctgcctygaccagcactttgaggatggctgtg

SEQ ID NO: 2 - DNA, 52 bp, Homo sapiens
aggaactccttggcctagcccaccctkctgccttctgacggccctgcaatgt

SEQ ID NO: 3 - DNA, 52 bp, Homo sapiens
ctgcttcccacctccctgcccaggccrgccagcctcacccttgcgaaccgtg

SEQ ID NO: 4 - DNA, 52 bp, Homo sapiens
gtcactattatggtttttattactatkgctctttttgaggaattgggaaatt

SEQ ID NO: 5 - DNA, 52 bp, Homo sapiens
ctgactctccccgacccgtcccaccayggtctccacagcactcccgacagcc

SEQ ID NO: 6 - DNA, 52 bp, Homo sapiens
ccaccagctgactctccccgacccgtsccaccacggtctccacagcactccc

SEQ ID NO: 7 - DNA, 52 bp, Homo sapiens
acccatctcactggcccctccctttcmccctctgaagactcctgcaaacacc

SEQ ID NO: 8 - DNA, 52 bp, Homo sapiens
ttttgctgagtgaccttaggcaagttkcttaccttctatgagcctgtttcct

SEQ ID NO: 9 - DNA, 52 bp, Homo sapiens
tgtgatgaatgggtgccaaatacacaratacagaatctaagaaaacacatgg

SEQ ID NO: 10 - DNA, 52 bp, Homo sapiens
ctagaggaagtgatgttcaacagacaracaactgaaggatgtgtaggaatta

SEQ ID NO: 11 - DNA, 52 bp, Homo sapiens
tggaagtcatgtgctttgtatgaaacrccttggaatgctgataagtttaatt

SEQ ID NO: 12 - DNA, 52 bp, Homo sapiens
gtctaaagcaaatggaacctttagggrgagagatttgtgtttgctgtgtccc

SEQ ID NO: 13 - DNA, 52 bp, Homo sapiens
gaggggactggggtcaggcctcattcrggttccctagagtggaaaggattgg

SEQ ID NO: 14 - DNA, 52 bp, Homo sapiens
gtatcagacagatctaggctcaaatamcagcttcagttctcaccacctgtgt

SEQ ID NO: 15 - DNA, 52 bp, Homo sapiens
cctgagtgcacaggatgctggagcctyccagtttctctggctttcatctcgt

SEQ ID NO: 16 - DNA, 51 bp, Homo sapiens
  modified_base (26)..(26): May or may not be present
aatcccccaacccctcctacccgttccaggccggggatcgccgaggaggta

SEQ ID NO: 17 - DNA, 52 bp, Homo sapiens
gaggacccagcctgcaatcacagcttrttactctgggtgtgggtgggagcgc

SEQ ID NO: 18 - DNA, 52 bp, Homo sapiens
gctcaatggttgctctaggaaagcagyattctgaagaggcttctaaagacaa

SEQ ID NO: 19 - DNA, 52 bp, Homo sapiens
ctgtgaactcaggagcaagtgcacacrttgcttatcacttaccagaagcatt

SEQ ID NO: 20 - DNA, 52 bp, Homo sapiens
  modified_base (27)..(27): May or may not be present
ctctggttttaagcaagtcatttaatyggagttttttttctcccataaaatg

SEQ ID NO: 21 - DNA, 52 bp, Homo sapiens
aaatggtcctaccatctatccagatayacagcttaaaaacttaggagtctct

SEQ ID NO: 22 - DNA, 52 bp, Homo sapiens
tgctatttgtaatgctgcttattagakacatcgctgatcctcctgtcaactc

SEQ ID NO: 23 - DNA, 52 bp, Homo sapiens
atgaaccaaattgcatgagctctattrtgtgcccctcttgtaatataaaaat

SEQ ID NO: 24 - DNA, 52 bp, Homo sapiens
caggcagaatttccacaaatgaaatgsaaattcagatatatatctcttaatc

SEQ ID NO: 25 - DNA, 52 bp, Homo sapiens
tcactcataactgaagatcatttcacytttgaatgagaatttgtctctgaag

SEQ ID NO: 26 - DNA, 52 bp, Homo sapiens
tgggcagaggaggggaagggtcactgyactcagggacaagagaaggggtggg

SEQ ID NO: 27 - DNA, 52 bp, Homo sapiens
atcagtgtggtcacttcactgcttgcsaaggattccatctaattctgaggaa

SEQ ID NO: 28 - DNA, 52 bp, Homo sapiens
tatgtcctcggagtgctgtgagtgtcyggcacttccatccaaagccaacagt

SEQ ID NO: 29 - DNA, 52 bp, Homo sapiens
ggaggggggtcttgccctcagcctcaygcaggttggggtcagcctgacggga

SEQ ID NO: 30 - DNA, 52 bp, Homo sapiens
cctgcaagctgtcgctgcgccagcccrgggaggtgagtgtgtgggctgggca

SEQ ID NO: 31 - DNA, 52 bp, Homo sapiens
actttgcagcccagaatggggatgacsgcactgcgcgcctgctcctggacca

SEQ ID NO: 32 - DNA, 52 bp, Homo sapiens
  modified_base (27)..(27): May or may not be present
aatttcccaaaaactacagtttttttttcttagcatgctattcaggtaaaca

SEQ ID NO: 33 - DNA, 52 bp, Homo sapiens
tttgctaggtaaggttcagcacccatytgctgtggccttcctatgaaacgta

SEQ ID NO: 34 - DNA, 52 bp, Homo sapiens
atgactagtcgtggagatgtcttcgtmcagttcttcgggaagagaggagttc

SEQ ID NO: 35 - DNA, 52 bp, Homo sapiens
gaaaacacaagtgtgatcaaatgccayggacccacaggaagctggtggctct

SEQ ID NO: 36 - DNA, 52 bp, Homo sapiens
tatatggcatttcacattcacatgtartatttgaatatacacatcaacacca

SEQ ID NO: 37 - DNA, 52 bp, Homo sapiens
ctaattaggatattttgtgggttttaraaaagtgaattttattaatatttga

SEQ ID NO: 38 - DNA, 52 bp, Homo sapiens
acaccacacctggcagttcagagcacrctcactctttctccctttgacagaa

SEQ ID NO: 39 - DNA, 52 bp, Homo sapiens
atcaggttggcctaatttacgtaaacrttaatttaaatcacactaatggttt

SEQ ID NO: 40 - DNA, 52 bp, Homo sapiens
ggaaggaatacatccaaactcattctrtgaggccagtattaccctgatgcca

SEQ ID NO: 41 - DNA, 52 bp, Homo sapiens
taataattgagtctccttccaattaamtcatggaacatcagagccattatat

SEQ ID NO: 42 - DNA, 52 bp, Homo sapiens
aagaaattgtctgcatataaacaaatrcatcacatttccacaaaagactttg

SEQ ID NO: 43 - DNA, 52 bp, Homo sapiens
tgagagctaatgtttcaaagaaacttkaaattcccaagattaaaattattgt

SEQ ID NO: 44 - DNA, 52 bp, Homo sapiens
cccagtaagtgaattaaatactttcayagacactctccatctagtagaacaa

SEQ ID NO: 45 - DNA, 52 bp, Homo sapiens
tgataggcactggttctacagtgagayatatctctcctaagtctggtgacaa

SEQ ID NO: 46 - DNA, 52 bp, Homo sapiens
acagtggcacgatctcggctcactgcmacctccacctcccgggtttaagtga

SEQ ID NO: 47 - DNA, 52 bp, Homo sapiens
ttacctggctaacagttttctatctcycacacgagcctggtgggaggcagtg

SEQ ID NO: 48 - DNA, 52 bp, Homo sapiens
agctcttgttatcttaccattcccacrttgattctcatttttatccctctcc

SEQ ID NO: 49 - DNA, 52 bp, Homo sapiens
tcaagatagctaattgagaacaagcaygagactccactcctggtccccaagc

SEQ ID NO: 50 - DNA, 52 bp, Homo sapiens
ccattttcttttcttctttgcttgtcktttttttctgtttgtttttcttttc

SEQ ID NO: 51 - DNA, 52 bp, Homo sapiens
agaaaataacttttgctagattcaccrttggttatagacctgcatgatctaa

SEQ ID NO: 52 - DNA, 52 bp, Homo sapiens
gtgatgttaccagcctgagggaaggarggttcacagcctgatatgttggtga

SEQ ID NO: 53 - DNA, 52 bp, Homo sapiens
agttagctctggtcaaggctaaaaatsaatgagcaaaatggcagtattaaca

SEQ ID NO: 54 - DNA, 52 bp, Homo sapiens
aattttattagattaaacaatttttarcagacctcatgcttgttggagataa

SEQ ID NO: 55 - DNA, 52 bp, Homo sapiens
ggtccagggtacacaaccaagcagccwtgctctagagcccagcaagacaggg

SEQ ID NO: 56 - DNA, 52 bp, Homo sapiens
actgaagaataatcatgcttaactcargagaaatgctccaccagacgggctg

SEQ ID NO: 57 - DNA, 52 bp, Homo sapiens
gcacatttactgttttgtctaacctgyctagccatttcagtcaagctgattg

SEQ ID NO: 58 - DNA, 52 bp, Homo sapiens
gcaatcagaaagaaattcagttattayagtatatgcaagtcacactgcaagc

SEQ ID NO: 59 - DNA, 52 bp, Homo sapiens
aatgaaacacaaatcataatctctgargcaaataagaatggaaggactcctg

SEQ ID NO: 60 - DNA, 52 bp, Homo sapiens
tttagggcaagtcagaaagtccaaaartgcctcagatattctgtgtgagtga

SEQ ID NO: 61 - DNA, 52 bp, Homo sapiens
aaaaactgggcctgagctcagatgaaytggagaactgaactttggcttagaa

SEQ ID NO: 62 - DNA, 52 bp, Homo sapiens
gagtcatcagctcccaaggttttctgyatggctctgtttttatgatttctgt

SEQ ID NO: 63 - DNA, 52 bp, Homo sapiens
gtgtgtactgcagtctggtcccatcgyattgccttgtgggatttgggagtag

SEQ ID NO: 64 - DNA, 52 bp, Homo sapiens
gctcctacggtccctcaggcttggagrgtcactttaaacaataaaaagcaac

SEQ ID NO: 65 - DNA, 52 bp, Homo sapiens
tgtggttactttctggagagagcatgyggcatgcaggagctggagggggggt

SEQ ID NO: 66 - DNA, 52 bp, Homo sapiens
aaaagttacgcttaataatgaatgttkcagcactttcttctcttcaggtatt

SEQ ID NO: 67 - DNA, 52 bp, Homo sapiens
ctgtgaggcactgaggatgccctcacrcgtgcatctgcatgtggcgtgcatg

SEQ ID NO: 68 - DNA, 52 bp, Homo sapiens
ctggtttgtgtatgttcttggtaaacyagcccttggtcttacacatcatttc

SEQ ID NO: 69 - DNA, 52 bp, Homo sapiens
gcttccctgttctcttctgctctgtcytctggtgccctgaggctggcctcca

SEQ ID NO: 70 - DNA, 52 bp, Homo sapiens
ggcatttctgaaccttgcccctctgcraacacaagggggcgatggtggcact

SEQ ID NO: 71 - DNA, 52 bp, Homo sapiens
ataagtaactgtcgagaagattctcayaggagaccacgtgggttgcctgaag

SEQ ID NO: 72 - DNA, 52 bp, Homo sapiens
aatgtcctcagctggttcttcccccartgccctgatcctgggctcacatgtg

SEQ ID NO: 73 - DNA, 52 bp, Homo sapiens
gagacgaagaccccaggaagtcatccygcaatgggagagacacgaacaaacc

SEQ ID NO: 74 - DNA, 52 bp, Homo sapiens
aaaatcaagtaatgattgatttgtagragtttgagtgaggcatcggatcccc

SEQ ID NO: 75 - DNA, 52 bp, Homo sapiens
accgtgcccagccctgtgtgggcatcrgaggtggttccctctggtcctgtcg

SEQ ID NO: 76 - DNA, 52 bp, Homo sapiens
gtccaggccccaggagctgccgcagcrggcagtggaaggaaggcacgttcag

SEQ ID NO: 77 - DNA, 52 bp, Homo sapiens
cagcttcccctcccaacacagaggcgmggcccaagtgcaggactcacaacgg

SEQ ID NO: 78 - DNA, 52 bp, Homo sapiens
aagacacagtgacggtatactcatgayggaatatgattcggccttaaaacaa

SEQ ID NO: 79 - DNA, 52 bp, Homo sapiens
aaggcgaagccggcgatggtacgtacrttggtgacgcagaacagggacagga

SEQ ID NO: 80 - DNA, 52 bp, Homo sapiens
gccatcgccacgctccctctgtcctcrgcctgggccgtggtcttcttcatca

SEQ ID NO: 81 - DNA, 52 bp, Homo sapiens
tgcttcctgctaccagcaggcagactyggatggaggtggaggggacgagagt

SEQ ID NO: 82 - DNA, 52 bp, Homo sapiens
cacggtaaaaatacaaggacagtgtgwgcagcagaatggccaggcagaccac

SEQ ID NO: 83 - DNA, 52 bp, Homo sapiens
gccaggcaggggctggtggaggtgcasggcctggaggaacacagagcccagc

SEQ ID NO: 84 - DNA, 52 bp, Homo sapiens
aggagaggacgtttgcgcgattctccscagatccagtgtttcccgtcagcca

SEQ ID NO: 85 - DNA, 52 bp, Homo sapiens
ggctcgtggccctgcgggcggatcttkggaagagcttgttcacactcaccta

SEQ ID NO: 86 - DNA, 52 bp, Homo sapiens
tcgaggcagggccaccggggacgtccragaacattggtgatcccttcccagg

SEQ ID NO: 87 - DNA, 52 bp, Homo sapiens
aatgcaggcgtgggacaaggcagctcygagtcctgctcaatggttttgtgac

SEQ ID NO: 88 - DNA, 52 bp, Homo sapiens
gagctcatccttgtcaaggagcagaayggagtgcagctcaccagctccaccc

SEQ ID NO: 89 - DNA, 52 bp, Homo sapiens
gtggggaggggtgcaggggaaggaggrgcaaaccagagtgtctgtcttgagg

SEQ ID NO: 90 - DNA, 52 bp, Homo sapiens
aaacacgctgctgctggatccaaatgmcagaagtcgccctggctggggcggt

SEQ ID NO: 91 - DNA, 52 bp, Homo sapiens
ctgcgcgctggtgctctgggcagggckgggaggccgggcgaggactcgccag

SEQ ID NO: 92 - DNA, 52 bp, Homo sapiens
ggagccaggacgcgagggcgaccccgwcggcgggagggcggggcggggcgga

SEQ ID NO: 93 - DNA, 52 bp, Homo sapiens
cctttacagcctttacctaaggcagtrctcttgctgacattcaggacactaa

SEQ ID NO: 94 - DNA, 52 bp, Homo sapiens
tttggccttctctcttgggccaaggartttctgctctattgcatgttctcat

SEQ ID NO: 95 - DNA, 52 bp, Homo sapiens
gagagctccttggagatggaataggcyccaaggttagcctgtaattgcctcc

SEQ ID NO: 96 - DNA, 52 bp, Homo sapiens
ccttagcacctgtgtgtctatcattcygggcaggaaaacttgcacaattaaa

SEQ ID NO: 97 - DNA, 52 bp, Homo sapiens
cttcatccgggggtaagtgagatggargacttggtggggagctgcccagggt

SEQ ID NO: 98 - DNA, 52 bp, Homo sapiens
actatagctcccagagccagagctggkatcaaaccggctggccctgtggctt

SEQ ID NO: 99 - DNA, 52 bp, Homo sapiens
accagggcatcaagctcttccctggcyggctgaccctgcctcagccctagtc

SEQ ID NO: 100 - DNA, 52 bp, Homo sapiens
agggtgggggtggaggcactggaaggyagcttcctgctcttttgtgtccccc

SEQ ID NO: 101 - DNA, 52 bp, Homo sapiens
gactcccttcaggcagtcctttagtcmccagcctcacctttgctctcaatgt

SEQ ID NO: 102 - DNA, 52 bp, Homo sapiens
aaactctgggagattctcctattgacscagaaagcgattccttcactgatac

SEQ ID NO: 103 - DNA, 52 bp, Homo sapiens
aggattttcttacatttaaagcagaaygacactactgatacacaaaagtaaa

SEQ ID NO: 104 - DNA, 52 bp, Homo sapiens
gagaaatcttcggagggctcaccagcrtcacaagtaggtagaccagaagagg

SEQ ID NO: 105 - DNA, 52 bp, Homo sapiens
gtttacagaccttgtcagagttggtastaattccagaatataatcatttcaa

SEQ ID NO: 106 - DNA, 52 bp, Homo sapiens
tggttgacacagagatgccattctggsccaccaactttgggatcagctccgt

SEQ ID NO: 107 - DNA, 52 bp, Homo sapiens
gatttatttaaatcatctctaattctyacaactccgaaaagataagaaaaca

SEQ ID NO: 108 - DNA, 52 bp, Homo sapiens
gttggggatccagttggcctcattctragctggctgtggattcacagaagaa

SEQ ID NO: 109 - DNA, 52 bp, Homo sapiens
aagatacgggggaggaaattcactggrttttacaatatatttttcaaggcaa

SEQ ID NO: 110 - DNA, 52 bp, Homo sapiens
gacaaaaagcaattgaggtccaggagstgccgcccacccggctcctcctctg

SEQ ID NO: 111 - DNA, 52 bp, Homo sapiens
gctgtcagcacctggtacaaataccargatagggtttttggggccacatttt

SEQ ID NO: 112 - DNA, 52 bp, Homo sapiens
gcatgccagttgcccactgtggcaatmaatatctgagcctgtggtttttgcc

SEQ ID NO: 113 - DNA, 52 bp, Homo sapiens
aggttccttgcgactgctgtgaatttwgtgatgcacttggatagtctctgtt

SEQ ID NO: 114 - DNA, 52 bp, Homo sapiens
gatgacaacatgcaaactttatggccrgaaaccaaagagtcaggcaaaatat

SEQ ID NO: 115 - DNA, 52 bp, Homo sapiens
aaaagaaagtaaacatatttaaggtcrtaaataaggccatgtctaatagtga

SEQ ID NO: 116 - DNA, 52 bp, Homo sapiens
aggaatgttctgatggcttggcccagktggtgactgtgcagatagactgaag

SEQ ID NO: 117 - DNA, 52 bp, Homo sapiens
tcagcacccaagggaccatcaaagagrctgttgtggagagggaatccgaagg

SEQ ID NO: 118 - DNA, 52 bp, Homo sapiens
tggagtgtttttccttcaccttttccrgtctctgggttgcatcgccagactg

SEQ ID NO: 119 - DNA, 52 bp, Homo sapiens
tgtctagccctgtgggtttacattagwtagggtaggttattgctgcaacgta

SEQ ID NO: 120 - DNA, 52 bp, Homo sapiens
ctatccaggatggctctaaagggactycgctataggttggggctatgataga

SEQ ID NO: 121 - DNA, 52 bp, Homo sapiens
gcttatattcaaagctccaggtaaatrtaagatgttgctataattacctaag

SEQ ID NO: 122 - DNA, 52 bp, Homo sapiens
ggtaggcaggtggatctgaaatctcayatagtaccaagacacgtgactagga

SEQ ID NO: 123 - DNA, 52 bp, Homo sapiens
ttgattcttatacttttttgtttagtygttgaaatatgttgttttggttgaa

SEQ ID NO: 124 - DNA, 52 bp, Homo sapiens
aattaggaagatttgagtagctaaaarttccaagagtggaataatagtttta

SEQ ID NO: 125 - DNA, 52 bp, Homo sapiens
tttggtgcactcccaatttactctaawcttctacgggcttccttggagaaac

SEQ ID NO: 126 - DNA, 52 bp, Homo sapiens
gacctgaaaataggtgagctgtcaagktgttggcagggagaggctcctctgg

SEQ ID NO: 127 - DNA, 52 bp, Homo sapiens
tggttcactgcatattcccagtaattsgaacaatgcctgacatgaagtagac

SEQ ID NO: 128 - DNA, 52 bp, Homo sapiens
ttagaatgtctgaattattattctagrttccttgcgactgctgtgaattttg

SEQ ID NO: 129 - DNA, 52 bp, Homo sapiens
ttgatttcggtagtcataacaccaccytggaaggcaccctagatagaggtca

SEQ ID NO: 130 - DNA, 52 bp, Homo sapiens
ttcattctacctgtctttagtatcatrggggtagttacctcagcgggggtag

SEQ ID NO: 131 - DNA, 52 bp, Homo sapiens
ttgctcaaggtcacacagtaaccttargtaggcaggataagctctggttctg

SEQ ID NO: 132 - DNA, 52 bp, Homo sapiens
tatgatggttaggttaggttgcaagtyttggaatatatgcagaggaataact

SEQ ID NO: 133 - DNA, 52 bp, Homo sapiens
ttataaacctctaaaatagttactaartaagttattcttttaggtatttttc

SEQ ID NO: 134 - DNA, 52 bp, Homo sapiens
ttttatttccgcaatcactccctaatstttatttcttttttgcttcgcatca

SEQ ID NO: 135 - DNA, 52 bp, Homo sapiens
tagcatttttctggagcgtaatttcayaatgtgaatcagaagtcttaatagt

SEQ ID NO: 136 - DNA, 52 bp, Homo sapiens
gagcacaggtggagagaaaggggagtragagaagcaaagaagaaaagccttt

SEQ ID NO: 137 - DNA, 52 bp, Homo sapiens
tagggacacaaaaagggacatactacrtgaattactaatatctaagaaaata

SEQ ID NO: 138 - DNA, 52 bp, Homo sapiens
atgaattactaatatctaagaaaataygatacatttgagaacttagatgaag

SEQ ID NO: 139 - DNA, 52 bp, Homo sapiens
gaaatgtggtgtagacgtgacccaggrggaaatgagttttgttggacagatt

SEQ ID NO: 140 - DNA, 52 bp, Homo sapiens
ctacatctcctacttagccgaggtctyttcactctctgggcaagtctcctca

SEQ ID NO: 141 - DNA, 52 bp, Homo sapiens
acacggctgaagagtcaggagtgggaygaaaaatacacttcatttgtaggtg

SEQ ID NO: 142 - DNA, 52 bp, Homo sapiens
gcacatttatgccttttatatgccacrtacacacgaaaactccatatattct

SEQ ID NO: 143 - DNA, 52 bp, Homo sapiens
agagtgaataaaattatttctaaattyatgcttcataccgtgtgtaatttag

SEQ ID NO: 144 - DNA, 52 bp, Homo sapiens
tgttgcaacagagatgatggcagtttyggccacggtgtaagaagcagaggtg

SEQ ID NO: 145 - DNA, 52 bp, Homo sapiens
acatctgccttcccagagaaaggaaartcaatgtttaaagtctatttaaaaa

SEQ ID NO: 146 - DNA, 52 bp, Homo sapiens
gggaagcaaaggagaagctgagaagaygaaggaaaagtcagggtctggaggg

SEQ ID NO: 147 - DNA, 52 bp, Homo sapiens
ggaggcaataggttttgaggggcatgrggacggggttcagcctccagggtcc

SEQ ID NO: 148 - DNA, 52 bp, Homo sapiens
tggcccagaagacccccctcggaatcrgagcagggaggatggggagtgtgag

SEQ ID NO: 149 - DNA, 52 bp, Homo sapiens
tctttctgcatccccgtctttctccaygtttttttctctccatccctcccta

SEQ ID NO: 150 - DNA, 52 bp, Homo sapiens
gttgaatgcctggaaggtgaatacacrgatgaatggagagagaaaaccagac

SEQ ID NO: 151 - DNA, 52 bp, Homo sapiens
cattttacaatagataaatgcttgtgytacctaaagcacttagcacacagtt

SEQ ID NO: 152 - DNA, 52 bp, Homo sapiens
gctctgggaatgtctatcctatgcaayggagataaggactgagatacgccct

SEQ ID NO: 153 - DNA, 52 bp, Homo sapiens
atgcaatggagataaggactgagataygccctggtctcctgcagtaccctca

SEQ ID NO: 154 - DNA, 52 bp, Homo sapiens
ggagccccgtaggaatcgcagcgccarcggttgcaaggtaaggccccggcgc

SEQ ID NO: 155 - DNA, 52 bp, Homo sapiens
aagttcctgacctctgaatgagagggrctgtgtaaggccaatgcctgggagg

SEQ ID NO: 156 - DNA, 52 bp, Homo sapiens
aataaaaataaatgttcttccttgcawtgaagttaaatatgtaaattctcaa

SEQ ID NO: 157 - DNA, 52 bp, Homo sapiens
acttaggtattagagggtggccattayttgagagtgactatgaccacagtta

SEQ ID NO: 158 - DNA, 52 bp, Homo sapiens
tgggtgaatgtgttatgctctctcccrccaccatgtctttataccccctgat

SEQ ID NO: 159 - DNA, 52 bp, Homo sapiens
ctcccagtgggtgggagagaaaggacrtaaggaagcaagtggtaaaggccct

SEQ ID NO: 160 - DNA, 52 bp, Homo sapiens
atcccttcaccagagtgatttcctcgmggcaggtgcctggggtagccactgg

SEQ ID NO: 161 - DNA, 52 bp, Homo sapiens
ggactgcctggttgtgcttcggacccrgaggcagacagaggaggcctttgaa

SEQ ID NO: 162 - DNA, 52 bp, Homo sapiens
cccactaggcaagcctcctaaaagcartatggttgtagatcactggaaaata

SEQ ID NO: 163 - DNA, 52 bp, Homo sapiens
gtaaacatgcaaactgaaacattagcrcccatttattcagcatcttagaaga

SEQ ID NO: 164 - DNA, 52 bp, Homo sapiens
gagtgaaggccaggtacagaggaaatraagcattccaaataatgccaggtaa

SEQ ID NO: 165 - DNA, 52 bp, Homo sapiens
ccaaagttaacttgtgaacccttctartaaactgctccaagatatgacaaaa

SEQ ID NO: 166 - DNA, 52 bp, Homo sapiens
gtttgccatggatgaaccaccaggatrgtgggggagacagaaaaggttgatg

SEQ ID NO: 167 - DNA, 52 bp, Homo sapiens
ggaaaattccccttcccctaagacatycacccttctggtttgggtaattcct

SEQ ID NO: 168 - DNA, 52 bp, Homo sapiens
gcagagagaaaccagttaattcagcgkcttccaatgggagctgtcattaagt

SEQ ID NO: 169 - DNA, 51 bp, Homo sapiens
gtgcatgatgtattacaaggaggccktctggaagaagaagggtaggctgct

SEQ ID NO: 170 - DNA, 52 bp, Homo sapiens
agagaaggaagtggtgtccccacaaakgaattgctaaggagttccacagcct

SEQ ID NO: 171 - DNA, 52 bp, Homo sapiens
aagagaaaacaaagctgaaatgctgcragtcaataatatcgttgctttaaca

SEQ ID NO: 172 - DNA, 52 bp, Homo sapiens
tttgacaactatttctagaatttgcaytgaactctgcttttccttttaaatt

SEQ ID NO: 173 - DNA, 52 bp, Homo sapiens
ggtctcgggaaggtgaccgagaaagayatctgggtacaagaacctgaatcaa

SEQ ID NO: 174 - DNA, 52 bp, Homo sapiens
ctgtcccacaacatggggtcttacagytctttgatgtatccccccacagggg

SEQ ID NO: 175 - DNA, 52 bp, Homo sapiens
gcctctggggtcaccaggtacatcttygatcttggccacactggagagtcaa

SEQ ID NO: 176 - DNA, 52 bp, Homo sapiens
tttctaaacacagaggactggtgttgygttatgcaaagaaaaatgcttctta

SEQ ID NO: 177 - DNA, 52 bp, Homo sapiens
aagacactcaggtgcagggaccctctmcatttttgcccagcagcagccatgc

SEQ ID NO: 178 - DNA, 52 bp, Homo sapiens
agggccaggaaccatgaaccagcgcgkgtgggggcagcctcttcaggcctgg

SEQ ID NO: 179 - DNA, 52 bp, Homo sapiens
ggcacaccagtccttttgagccccagygtccccaggttaataacctagaatt

SEQ ID NO: 180 - DNA, 52 bp, Homo sapiens
tgaacacggaggccacacaagagtggrttccaagtgaaggagtgaccaactc

SEQ ID NO: 181 - DNA, 52 bp, Homo sapiens
tcctttcctgggatcacagagggaagygcgggggagcctagagagcaccaca

SEQ ID NO: 182 - DNA, 52 bp, Homo sapiens
tacaggtgaaggaaagtgattctttcyccgttaactttgtttcacgccagat

SEQ ID NO: 183 - DNA, 52 bp, Homo sapiens
cccccaaccagagatgatgatgggggrcaggggaggcaccaaaccctgggcc

SEQ ID NO: 184 - DNA, 52 bp, Homo sapiens
agcagcatacccctagggacctaggarcagggagggagagaggcagccctgg

SEQ ID NO: 185 - DNA, 52 bp, Homo sapiens
cagctggcactgacagcctgggggggscgctctccccctgcagccgtgcagg

SEQ ID NO: 186 - DNA, 52 bp, Homo sapiens
gagcacaagaaggccagcccactgggscctggggctgccctcggcaaccgtg

SEQ ID NO: 187 - DNA, 52 bp, Homo sapiens
ctgcttcccaccaatcagcacagctcmtgcctggggctgggacacactcccg

SEQ ID NO: 188 - DNA, 52 bp, Homo sapiens
atcagaatgtgtggcttgcaagaaccrgctcagatcctgcccttcaaaaaca

SEQ ID NO: 189 - DNA, 52 bp, Homo sapiens
gttctactgctattagctctgcccggkcatgaccaggaaaccacgactcaag

SEQ ID NO: 190 - DNA, 52 bp, Homo sapiens
gatgacaagccaggcagggaggaatgracctggattcctggtgaaggacgtg

SEQ ID NO: 191 - DNA, 52 bp, Homo sapiens
gtcagcgattcttaatataagaaaaartggtgaaatgtgtttagagtgtgct

SEQ ID NO: 192 - DNA, 52 bp, Homo sapiens
cctggggtgcaggacgccgcgctgatygaggccatccaggaccgcctgtcca

SEQ ID NO: 193 - DNA, 52 bp, Homo sapiens
gttcctggggccacagacaggcctgcrcattcccaatactcaggctctgctc

SEQ ID NO: 194 - DNA, 52 bp, Homo sapiens
cataagacctacgaccccacctactcygacttctgccagttccggcctccag

SEQ ID NO: 195 - DNA, 52 bp, Homo sapiens
tggcctgcttgctgttcttacagggayggaggcaatggcggccagcacttcc

SEQ ID NO: 196 - DNA, 52 bp, Homo sapiens
tgtgggggtgggccagcccagcttagrttatcttggctcattgtccactagt

SEQ ID NO: 197 - DNA, 52 bp, Homo sapiens
tctgtcctcaggccagggcttcgctgmagccccggccactccctagtgcctg

SEQ ID NO: 198 - DNA, 52 bp, Homo sapiens
tacgaactcactgtaaaactcaccttygccataagaccttcttcaactaagt

SEQ ID NO: 199 - DNA, 52 bp, Homo sapiens
acagagtttacgaactcactgtaaaaytcaccttcgccataagaccttcttc

SEQ ID NO: 200 - DNA, 52 bp, Homo sapiens
ggagagaaaacaaagtcaatggggcaygtgtgggaaaccagcctgacctgtg

SEQ ID NO: 201 - DNA, 52 bp, Homo sapiens
ttacagggacttccaaggaagatgccrtgaaagcttacatcaacaaagtaga

SEQ ID NO: 202 - DNA, 52 bp, Homo sapiens
ttgggaaaggagagtctgaagggacartgcatggtcggagagcagtgacaat

SEQ ID NO: 203 - DNA, 52 bp, Homo sapiens
aaattggaaatctgtaacgcagcttcygtaagcatgtgtgggcaaaaaagca

SEQ ID NO: 204 - DNA, 52 bp, Homo sapiens
ttctttccatctggcacctatttattsactatttatgcattcgttgaattat

SEQ ID NO: 205 - DNA, 52 bp, Homo sapiens
ctctttcaccattgacaaatatttatkgacgacttactttctatgtaaggtc

SEQ ID NO: 206 - DNA, 52 bp, Homo sapiens
cgttcagtttagtaagcaaaggcttcytggcttctctggtgatggggtttgt

SEQ ID NO: 207 - DNA, 52 bp, Homo sapiens
agcttaccatttaagtagaactgtttragatgctggacattctaatacaatc

SEQ ID NO: 208 - DNA, 52 bp, Homo sapiens
ccaaatctgaaatttacttgtcacttyagagttgtctttgaacggaaagatt

SEQ ID NO: 209 - DNA, 52 bp, Homo sapiens
tctgttgagtgataatctttctcgcarataactcacaatatttaaaaattgt

SEQ ID NO: 210 - DNA, 52 bp, Homo sapiens
aagaactcttccatgattgaaatggtmgcacatggaataacatcgataagtt

SEQ ID NO: 211 - DNA, 52 bp, Homo sapiens
acagcaggttggagcacagggcctaartgggaggccagggaggtgggcagag

SEQ ID NO: 212 - DNA, 52 bp, Homo sapiens
attgctgattttcaggcaaactatgtwacatggctttcaatgggtgcttggc

SEQ ID NO: 213 - DNA, 52 bp, Homo sapiens
gaagcagttagttctgacaccaacaartggtgataagaggttgatagcctag

SEQ ID NO: 214 - DNA, 52 bp, Homo sapiens
gtggggggaggagctgaccagtgaagmaagtgtctttgaagtctttgttctt

SEQ ID NO: 215 - DNA, 52 bp, Homo sapiens
cttgaaggagaaggtgtctgcgggagycgatttcatcatcacgcagcttttc

SEQ ID NO: 216 - DNA, 40 bp, Homo sapiens
agatgttccaccccgggcctggacccygagcggcatgaga

SEQ ID NO: 217 - DNA, 52 bp, Homo sapiens
caggtaactgacccttcacacatttayggtgcccatctgacattcatagcat

SEQ ID NO: 218 - DNA, 52 bp, Homo sapiens
gcgcgcgggcgtgcgagcagcgaaagsgacaggggcaaagtgagtgacctgc

SEQ ID NO: 219 - DNA, 52 bp, Homo sapiens
agacatgtcccatttgtgggaactgtracccttcctgtgtgagctggaggca

SEQ ID NO: 220 - DNA, 52 bp, Homo sapiens; identical to SEQ ID NO: 219

SEQ ID NO: 221 - DNA, 52 bp, Homo sapiens
acatcctgaggtgtgttctcttgggcytggcaggcatggagagctctggttc

SEQ ID NO: 222 - DNA, 52 bp, Homo sapiens
agcattcccgggcgggtgacccagcayggtccctcttggaattggattcgcc

SEQ ID NO: 223 - DNA, 52 bp, Homo sapiens
atcctcttcctgctccccttcctgggrtgcagcctaaaaggacctatgtcct

SEQ ID NO: 224 - DNA, 52 bp, Homo sapiens
agggttattaggatgctgtggtcatgycgtgtgtggatgagtccatgctgtt